(19) United States
(12) Patent Application Publication
(10) Pub. No.: US 2015/0025845 A1
(43) Pub. Date: Jan. 22, 2015

(54) SURFACE MEASUREMENT APPARATUS AND METHOD

(71) Applicant: Taylor Hobson Limited, Leicester, Leicestershire (GB)

(72) Inventor: Daniel Ian Mansfield, Leicester (GB)

(73) Assignee: Taylor Hobson Limited, Leicester, (GB)

(21) Appl. No.: 14/381,068

(22) PCT Filed: Feb. 27, 2013
(86) PCT No.: PCT/GB2013/050485

§ 371 Date: Aug. 26, 2014

(30) Foreign Application Priority Data
Feb. 27, 2012 (GB) 1203322.1
Feb. 27, 2012 (GB) 1203343.7
Feb. 27, 2012 (GB) 1203365.0

(51) Int. Cl. G01B 5/20; G01B 5/008; G01B 21/04; G01D 5/347

(52) U.S. Cl. CPC G01B 5/20; G01D 5/347; G01B 5/008; G01B 21/047
USPC 702/168

(57) ABSTRACT

A stylus is deflected as a tip of the stylus follows surface variations along a measurement path on a surface of a workpiece. A transducer provides measurement data in a measurement coordinate system. A data processor is configured to: determine a relationship between the data in the measurement coordinate system and nominal surface data representing the expected surface characteristic of the workpiece in a workpiece coordinate system; simulate a measurement data set for the nominal surface using the nominal surface data and the determined relationship; if a simulated range of the simulated data set does not meet a given criterion, adjust a selected measurement data value for a selected point and repeat the simulation to determine an adjusted data value for which the simulated range meets the criterion; and determine start conditions required for a measurement procedure to provide the adjusted data value for the selected measurement point.

This invention relates to a surface measurement apparatus and method for facilitating measurement of one or more surface characteristics, in particular surface form.

Surface form or profile measurements may be made by effecting relative movement between a pivotally mounted stylus arm and a workpiece along a traverse path (measurement path) and detecting, using a transducer, the deflection of the stylus arm as a tip of a stylus carried by the stylus arm follows variation in the form of the surface transverse to the traverse path. Accurate measurement requires care in the setting up of the apparatus which can be time consuming.

Measurement of surfaces having significant form, such as aspheric lenses as may be used in optical storage devices such as digital versatile discs (DVD) recorders and players, and moulds for such lenses, present particular challenges because the steepness of the local slope of the surface being measured may result in a higher than desired contact angle between stylus tip and the surface being measured increasing the likelihood of the stylus tip slipping or dragging on the surface which could render the measurement inaccurate and may also damage the stylus. Also the height (depth) to width aspect ratio of the form of the component may make access to the surface difficult, increasing the likelihood of collisions between the stylus arm and the workpiece surface which may, again, detrimentally affect the measurement and damage the stylus.

In order to address the above problems, Taylor Hobson Ltd of Leicester England have produced metrological apparatus sold under the trade name “Talysurf PGI Blu” which enables precision 3-D for measurement of shallow and steep-sided aspheric lenses and moulds and offers 100 nm measurement capability.

This apparatus addresses problems discussed above by enabling the orientation of a traverse unit carrying the stylus to be adjusted so that the stylus arm and the measurement path direction are inclined to the plane of a support surface, such as a turntable, on which the workpiece to be measured is mounted. Allowing the angle of the stylus arm to be adjusted reduces the possibility of the contact angle exceeding a desired limit and also should facilitate access to the surface to be measured. Setting up of the instrument at the start of a measurement procedure may, however, be more difficult for the operator because of the inclination of the traverse unit and the measurement path direction.

Embodiments of the present invention facilitate setting up of a metrological instrument for a measurement procedure allowing more rapid and accurate measurements of the surface characteristic to be made.

In one aspect, the present invention provides a metrological apparatus for measuring a surface characteristic of a workpiece, the apparatus comprising:

a mover to carry out a measurement procedure by effecting relative movement in a measurement direction between a workpiece and a stylus such that the stylus is deflected as a stylus tip of the stylus follows surface variations along a measurement path on a surface of the workpiece;

a transducer to provide a measurement data set in a measurement coordinate system representing the deflection of the stylus at measurement points along the measurement path, the transducer having a measurement range; and

a data processor configured to:

receive nominal surface data representing the expected surface characteristic of the workpiece in a workpiece coordinate system;

determine a relationship between the measurement data in the measurement coordinate system and the nominal surface data in the workpiece coordinate system;

simulate a measurement data set for the nominal surface using the nominal surface data and the determined relationship, the simulation providing a simulated measurement data set having a simulated range of simulated measurement values;

determine whether the simulated range meets a given criterion;

if the simulated range does not meet the given criterion, adjust a selected measurement data value for a selected measurement point and repeat the simulation to determine an adjusted measurement data value for which the simulated range meets the given criterion; and

determine measurement start conditions required for a measurement procedure to provide the adjusted measurement data value for the selected measurement point.

The selected measurement point may be a first measurement point of a measurement procedure.

The given criterion may be a point at which a difference between a maximum and minimum simulated measurement value is less than a threshold value.

The given criterion may be a point at which a difference between the magnitude of the maximum simulated measurement value and the magnitude of the minimum simulated measurement value is less than a threshold value.

The adjusted measurement data value may be a measurement data value based on the selected measurement data value and a difference between maximum and minimum simulated measurement values.

The adjusted measurement data value may be a measurement data value based on a difference between the selected measurement data value and an average or mean of maximum and minimum simulated measurement values.

The adjusted measurement data value may be G′₀=G₀−(Gₘₐₓ−Gₘᵢₙ)/2 where G₀ is the selected measurement data value, and Gₘₐₓ and Gₘᵢₙ are the maximum and minimum simulated measurement values.

The stylus may be movable by a traverse unit to move the stylus in the measurement direction.

The measurement direction may be at an angle β to an axis, x, of the workpiece coordinate system.

A pivotal mounting may be provided for the stylus such that an arm of the stylus pivots about a pivot axis as the stylus tip follows surface variations.

The surface characteristic may be a surface form of a surface of the workpiece.

In an embodiment, a pivotal mounting is provided for the stylus such that an arm of the stylus pivots about a pivot axis through an angle α as the stylus tip follows surface variations, the measurement coordinate system is given by G, X, where G is related to the angle α and X is the measurement direction, and wherein the workpiece coordinate system is x, z, where x is a direction along a workpiece support surface of the apparatus, z is a normal to the workpiece and X is at an angle β to x.

In an embodiment, the relationship may given by:

L cos(β+α₀)+X cos β−L cos α=xₛ.

L sin(β+αₒ)+X sin β+ΔZ_{col}−L sin α=zₛ

where
α is the degree of deflection of the stylus arm and α=αₒ+β−(G/L) where G is the measurement data or transducer output;

X is the traverse or measurement direction which extends at the angle β to the x axis;

ΔZ_{col} is the distance in the z direction when the stylus tip is at a measurement point on the surface being measured from the corresponding z position at which G=0;

α₀ is a pivot offset angle;

xₛ, zₛ is the centre of the stylus tip is the distance between the centre of the stylus tip and the pivot axis which on inversion:

$${Z}_{c} - {Z}_{flat} = Δ {Z}_{col} = \frac{L ( sin ( α - β ) - sin {α}_{o} ) - {x}_{s} sin β + {z}_{s} cos β}{cos β}$$

$$X = \frac{L ( cos α - cos ( β + {α}_{o} ) ) + {x}_{s}}{cos β}$$

The measurement data set may be simulated by simulating the nominal surface form and rotating the simulated nominal surface form to the measurement direction. A gauge calibration relationship relating a measurement data value and a measurement direction position to a distance z_{G} in z may be used to determine a data set in G and X and if the measurement range G does not meet the given criterion, the selected measurement data value for the selected measurement point adjusted until the range meets the given criterion.

In an embodiment, the measurement data set may be simulated by: simulating the nominal surface form and rotating the simulated nominal surface form by −β so that, referring to the nominal profile as zₛ(x)+z_{flat}, corresponding to the stylus tip centre traversing the part:

$$( \begin{matrix}{x}_{G} \\ {z}_{G}\end{matrix} ) = ( \begin{matrix}cos ( - β ) & - sin ( - β ) \\ sin ( - β ) & cos ( - β )\end{matrix} ) ( \begin{matrix}{x}_{s} \\ {z}_{s} ( {x}_{s} ) - ( {Z}_{c} - {Z}_{flat} )\end{matrix} )$$

determining gauge calibration relationships

z_{G}=α₁G+α₂G²+α₃G³

x_{G}=X+β₁z_{G}+β₂z_{G}²+β₃z_{G}³

deriving from the gauge relationships:

G=γ₁z_{G}+γ₂z_{G}²+γ₃z_{G}³

X=x_{G}−(β₁z_{G}+β₂z_{G}²+β₃z_{G}³)

setting G to a selected measurement data value, such as zero, determining a starting value for Z_{c}−Z_{flat} to be determined at S14 in accordance with:

$${Z}_{c} - {Z}_{flat} = Δ {Z}_{col} = \frac{L ( sin ( α - β ) - sin {α}_{o} ) - {x}_{s} sin β + {z}_{s} cos β}{cos β}$$

$$X = \frac{L ( cos α - cos ( β + {α}_{o} ) ) + {x}_{s}}{cos β}$$

then determining a (G, X) data set in accordance with:

$$( \begin{matrix}{x}_{G} \\ {z}_{G}\end{matrix} ) = ( \begin{matrix}cos ( - β ) & - sin ( - β ) \\ sin ( - β ) & cos ( - β )\end{matrix} ) ( \begin{matrix}{x}_{s} \\ {z}_{s} ( {x}_{s} ) - ( {Z}_{c} - {Z}_{flat} )\end{matrix} )$$

$$G = {γ}_{1} {z}_{G} + {γ}_{2} {z}_{G}^{2} + {γ}_{3} {z}_{G}^{3}$$

$$X = {x}_{G} - ( {β}_{1} {z}_{G} + {β}_{2} {z}_{G}^{2} + {β}_{3} {z}_{G}^{3} )$$

and, if the measurement range does not meet the given criterion, adjusting a selected measurement data value for a selected measurement point and repeating the determination of Z_{c}−Z_{flat} and the (G, X) data set to determine an adjusted measurement data value for which the range meets the given criterion.

In another aspect, the present invention provides a data processor for a metrological apparatus for measuring a surface characteristic of a workpiece, the apparatus comprising:

a mover to carry out a measurement procedure by effecting relative movement in a measurement direction between a workpiece and a stylus such that the stylus is deflected as a stylus tip of the stylus follows surface variations along a measurement path on a surface of the workpiece; and
a transducer to provide a measurement data set in a measurement coordinate system representing the deflection of the stylus at measurement points along the measurement path, the transducer having a measurement range, the data processor being configured to: receive nominal surface data representing the expected surface characteristic of the workpiece in a workpiece coordinate system;
determine a relationship between the measurement data in the measurement coordinate system and the nominal surface data in the workpiece coordinate system, which may be achieved using the stylus tip convolution discussed above;
simulate a measurement data set for the nominal surface using the nominal surface data and the determined relationship, the simulation providing a simulated measurement data set having a simulated range of simulated measurement values;
determine whether the simulated range meets a given criterion;
if the simulated range does not meet the given criterion, adjust a selected measurement data value for a selected measurement point and repeat the simulation to determine an adjusted measurement data value for which the simulated range meets the given criterion; and
determine measurement start conditions required for a measurement procedure to provide the adjusted measurement data value for the selected measurement point.

In another aspect, the present invention provides a method for facilitating measurement of a surface characteristic of a workpiece using an apparatus comprising:

a mover to carry out a measurement procedure by effecting relative movement in a measurement direction between a workpiece and a stylus such that the stylus is deflected as a stylus tip of the stylus follows surface variations along a measurement path on a surface of the workpiece; and
a transducer to provide a measurement data set in a measurement coordinate system representing the deflection of the stylus at measurement points along the measurement path, the transducer having a measurement range,
the method comprising:
determining a relationship between the measurement data in the measurement coordinate system and nominal surface data representing the expected surface characteristic of the workpiece in a workpiece coordinate system, which may be achieved using the stylus tip convolution discussed above;
simulating a measurement data set for the nominal surface using the nominal surface data and the determined relationship, the simulation providing a simulated measurement data set having a simulated range of simulated measurement values;
determining whether the simulated range meets a given criterion;
if the simulated range does not meet the given criterion, adjusting a selected measurement data value for a selected measurement point and repeating the simulation to determine an adjusted measurement data value for which the simulated range meets the given criterion; and
determining measurement start conditions required for a measurement procedure to provide the adjusted measurement data value for the selected measurement point.

In an embodiment, a stylus is deflected as a stylus tip of the stylus follows surface variations along a measurement path on a surface of a workpiece and a transducer provides measurement data in a measurement coordinate system. A data processor is configured to: determine a relationship between the measurement data in the measurement coordinate system and nominal surface data representing the expected surface characteristic of the workpiece in a workpiece coordinate system, which may be achieved using the stylus tip convolution discussed above;

simulate a measurement data set for the nominal surface using the nominal surface data and the determined relationship, the simulation providing a simulated measurement data set having a simulated range of simulated measurement values; if the simulated range does not meet a given criterion, adjust a selected measurement data value for a selected measurement point and repeat the simulation to determine an adjusted measurement data value for which the simulated range meets the given criterion; and
determine measurement start conditions required for a measurement procedure to provide the adjusted measurement data value for the selected measurement point.

In order to address the above problems, Taylor Hobson Ltd of Leicester England have produced metrological apparatus sold under the trade name “Talysurf PGI Blu” which enables precision 3-D for measurement of shallow and steep-sided aspheric lenses and moulds and offers 100 nm measurement capability.

This apparatus addresses problems discussed above by enabling the orientation (traverse angle) of a traverse unit carrying the stylus to be adjusted so that the stylus arm and the measurement path direction are inclined to the plane of a support surface, such as a turntable, on which the workpiece to be measured is mounted. Allowing the angle of the stylus arm to be adjusted reduces the possibility of the contact angle exceeding a desired limit and also should facilitate access to the surface to be measured. Nevertheless there is still a possibility that an operator may incorrectly set up the instrument at the start of a measurement procedure, for example may select an incorrect traverse angle or an incorrect stylus, which may result in a higher than desired contact angle or the possibility of a collision between the stylus arm and the workpiece surface.

Embodiments of the present invention aim to ameliorate the above issues.

Aspects and preferred examples of the present invention are set out in the appended claims.

Embodiments of the present invention facilitate setting up of a metrological instrument for a measurement procedure allowing more rapid and accurate measurements of the surface characteristic to be made.

In one aspect, there is provided a metrological apparatus for measuring a surface characteristic of a workpiece, the apparatus comprising:

a mover to carry out a measurement by effecting relative movement in a measurement direction between a workpiece support surface and a stylus such that the stylus is deflected as a stylus tip of the stylus follows surface variations along a measurement path on a surface of a workpiece supported on the workpiece support surface;
a transducer to provide measurement data representing the deflection of the stylus at measurement points along the measurement path; and
a data processor configured to:
to receive stylus characteristics data;
to define a representation of the stylus using the stylus characteristics data;
to receive nominal form data representing the expected form of a surface of the workpiece;
to simulate relative movement of the stylus representation and the nominal form along a measurement path to simulate a measurement;
to identify any measurement points along the measurement path for which the relative locations of the stylus representation and the nominal form are undesirable;
to output to a resource data alerting an operator in the event of determination of a measurement point for which the relative locations of the stylus representation and the nominal form are undesirable.

In another aspect, there is provided a method of facilitating measurement of a surface characteristic of a workpiece using an apparatus comprising:

a mover to carry out a measurement by effecting relative movement in a measurement direction between a workpiece support surface and a stylus such that the stylus is deflected as a stylus tip of the stylus follows surface variations along a measurement path on a surface of a workpiece supported on the workpiece support surface; and
a transducer to provide measurement data representing the deflection of the stylus at measurement points along the measurement path, the method comprising:
receiving stylus characteristics data;
defining a representation of the stylus using the stylus characteristics data;
receiving nominal form data representing the expected form of a surface of the workpiece;
simulating relative movement of the stylus representation and the nominal form along a measurement path to simulate a measurement;
identifying any measurement points along the measurement path for which the relative locations of the stylus representation and the nominal form are undesirable;
outputting to a resource data alerting an operator in the event of determination of a measurement point for which the relative locations of the stylus representation and the nominal form are undesirable.

In another aspect, there is provided a data processor for a metrological apparatus comprising:

a mover to carry out a measurement by effecting relative movement in a measurement direction between a workpiece support surface and a stylus such that the stylus is deflected as a stylus tip of the stylus follows surface variations along a measurement path on a surface of a workpiece supported on the workpiece support surface; and
a transducer to provide measurement data representing the deflection of the stylus at measurement points along the measurement path, the data processor being configured:
to receive stylus characteristics data;
to define a representation of the stylus using the stylus characteristics data;
to receive nominal form data representing the expected form of a surface of the workpiece;
to simulate relative movement of the stylus representation and the nominal form along a measurement path to simulate a measurement;
to identify any measurement points along the measurement path for which the relative locations of the stylus representation and the nominal form are undesirable;
to output to a resource data alerting an operator in the event of determination of a measurement point for which the relative locations of the stylus representation and the nominal form are undesirable.

Embodiments of the present invention facilitate setting up of a metrological instrument for a measurement procedure, enabling an operator to determine, before carrying out a measurement, whether his or her setup procedure is likely to result in any undesirable occurrences such as out of range contact angles and/or potential collisions, allowing more rapid and accurate measurements of the surface characteristic to be made.

The relative locations of the stylus representation and the nominal form may be determined to be undesirable in the event that a contact angle between the stylus tip of the stylus representation and the nominal form is outside a desired contact angle range. The contact angle may be determined to be the angle between the normal to the local nominal form gradient or tangent and the orientation of the part of the stylus at the stylus tip. As another possibility or additionally, the relative locations of the stylus representation and the nominal form may be determined to be undesirable in the event the representation of the stylus arm intersects or contacts the nominal form indicating a potential collision point.

In the event the relative locations of the stylus representation and the nominal form are undesirable, parameters of the simulation may be adjusted and proposed alternative parameters output to the resource, to assist an operator in improving a measurement procedure. At least one of a measurement direction and a stylus characteristic may be adjusted, for example an angle of a shank of the stylus may be adjusted. As another possibility, or additionally, stylus characteristics for different available styli may be stored and parameters adjusted by selecting stylus characteristics for a different stylus, assisting an operator in selection of a correct stylus.

In an embodiment a metrological apparatus has a mover to carry out a measurement by effecting relative movement in a measurement direction between a workpiece support surface and a stylus such that the stylus is deflected as a stylus tip of the stylus follows surface variations along a measurement path on a workpiece surface. A data processor is configured to define a representation of the stylus using stylus characteristics data, to receive nominal form data, to simulate relative movement of the stylus representation and the nominal form along a measurement path, to identify any measurement points along the measurement path for which the relative locations of the stylus representation and the nominal form are undesirable, and to output to a resource data alerting an operator in the event of determination of a measurement point for which the relative locations of the stylus representation and the nominal form are undesirable.

In order to address the above problems, Taylor Hobson Ltd of Leicester England have produced metrological apparatus sold under the trade name “Talysurf PGI Blu” which enables precision 3-D for measurement of shallow and steep-sided aspheric lenses and moulds and offers 100 nm measurement capability.

Where, as an example described above, the stylus is a pivotally mounted stylus, appropriate correction will generally need to be made for the fact that the stylus tip follows an arcuate path as it is deflected as it follows surface variations in the surface being measured. Whether or not the stylus is a pivotally mounted stylus, the measured data is corrected to determine the location at which the stylus tip surface is in contact with the surface being measured

Embodiments of the present invention provide a way of measuring surface form which avoids having to correct the measured data to determine the location at which the stylus tip actually contacts the surface being measured.

Aspects and preferred examples of the present invention are set out in the appended claims.

In one aspect, the present invention provides a metrological apparatus for measuring a surface characteristic of a workpiece, the apparatus comprising:

a mover to carry out a measurement by effecting relative movement in a measurement direction between a workpiece support surface and a stylus such that the stylus is deflected as a stylus tip of the stylus follows surface variations along a measurement path on a surface of a workpiece supported on the workpiece support surface;
a transducer to provide measurement data representing the deflection of the stylus at measurement points along the measurement path on the surface being measured; and
a data processor configured to:
to determine a location of a centre of the stylus tip at measurement points along a measurement path on a surface of a workpiece, the stylus tip locations defining a stylus tip locus; and
to determine a surface form of the surface being measured using the determined stylus tip locus.

In another aspect, the present invention provides a data processor for a metrological apparatus for measuring surface form, the data processor being configured:

to determine a location of a centre of a stylus tip at measurement points along a measurement path on a surface of a workpiece being measured, the stylus tip locations defining a stylus tip locus; and
to determine a surface form of the surface being measured using the determined stylus tip locus.

In another aspect, the present invention provides a method of measuring a surface characteristic of a workpiece using an apparatus comprising:

a mover to carry out a measurement by effecting relative movement in a measurement direction between a workpiece support surface and a stylus such that the stylus is deflected as a stylus tip of the stylus follows surface variations along a measurement path on a surface of a workpiece supported on the workpiece support surface; and
a transducer to provide measurement data representing the deflection of the stylus at measurement points along the measurement path on the surface being measured, the method comprising:
determining a location of a centre of the stylus tip at measurement points along a measurement path on a surface of a workpiece, the stylus tip locations defining a stylus tip locus; and
determining a surface form of the surface being measured using the determined stylus tip locus.

The form of the surface being measured may be determined using the determined stylus tip locus and the gradient of the stylus tip locus.

The stylus tip locus may be determined in accordance with:

zₛ=z+r cos ψ

xₛ=x−r sin ψ

where (x, z) is the point of contact and r is a radius of the stylus tip or at least the part of the stylus tip that contacts the surface and

$$tan Ψ = \frac{d z}{d x}$$

where

In an embodiment, the form of the surface being measured may be determined using the determined stylus tip locus:

zₛ=z+r cos ψ

xₛ=x−r sin ψ

where (x, z) is the point of contact of the stylus tip with the surface being measured, (xₛ, zₛ) is the centre of the stylus tip and r is a radius of the stylus tip or at least the part of the stylus tip that contacts the surface and
where

$$tan Ψ = \frac{d z}{d x}$$

and by determining the gradient of the stylus-tip centre locus by taking differentials

$$\frac{d {z}_{s}}{d x} = \frac{d z}{d x} - r sin Ψ \frac{d Ψ}{d x}$$

$$\frac{d {x}_{s}}{d x} = 1 - r cos Ψ \frac{d Ψ}{d x}$$

$$with$$

$$\frac{d Ψ}{d x} = {cos}^{2} Ψ \frac{{d}^{2} z}{d {x}^{2}}$$

$$giving \text{:}$$

$$\frac{d {z}_{s}}{d {x}_{s}} = \frac{tan Ψ - r sin {Ψcos}^{2} Ψ \frac{{d}^{2} z}{d {x}^{2}}}{1 - r cos {Ψcos}^{2} Ψ \frac{{d}^{2} z}{d {x}^{2}}} = \frac{sin Ψ - r sin {Ψcos}^{3} Ψ \frac{{d}^{2} z}{d {x}^{2}}}{cos Ψ - r cos Ψ {cos}^{3} Ψ \frac{{d}^{2} z}{d {x}^{2}}} \\ ⇒ \frac{d {z}_{s}}{d {x}_{s}} = tan Ψ$$

and then re-creating the surface form accordance with:

z=zₛ−r cos ψ

x=xₛ+r sin ψ

In an embodiment, the form of the surface being measured may be determined using the determined stylus tip locus xₛ yₛ zₛ:

z=zₛ−r cos ψ

x=xₛ+r sin ψ cos θ

y=yₛ+r sin ψ sin θ

where

$$tan θ = \frac{\partial {z}_{s}}{\partial {y}_{s}} / \frac{\partial {z}_{s}}{\partial {x}_{s}}$$

and where

$$tan Ψ = \frac{\partial {z}_{s}}{\partial {x}_{s}} / cos θ$$

Application of these relationships allows the 3D surface form to be re-created from the stylus tip centre locus.

The determined surface form may be output to a resource such as a display, printer, network connection or another computer.

An embodiment provides a metrological apparatus has a mover to carry out a measurement by effecting relative movement in a measurement direction between a workpiece support surface and a stylus such that the stylus is deflected as a stylus tip of the stylus follows surface variations along a measurement path on a workpiece surface. A data processor is configured to determine a location of a centre of the stylus tip at measurement points along a measurement path on a surface of a workpiece, the stylus tip locations defining a stylus tip locus; and to determine a surface form of the surface being measured using the determined stylus tip locus.

Embodiments of the present invention will now be described, by way of example, with reference to the accompanying drawings, in which:

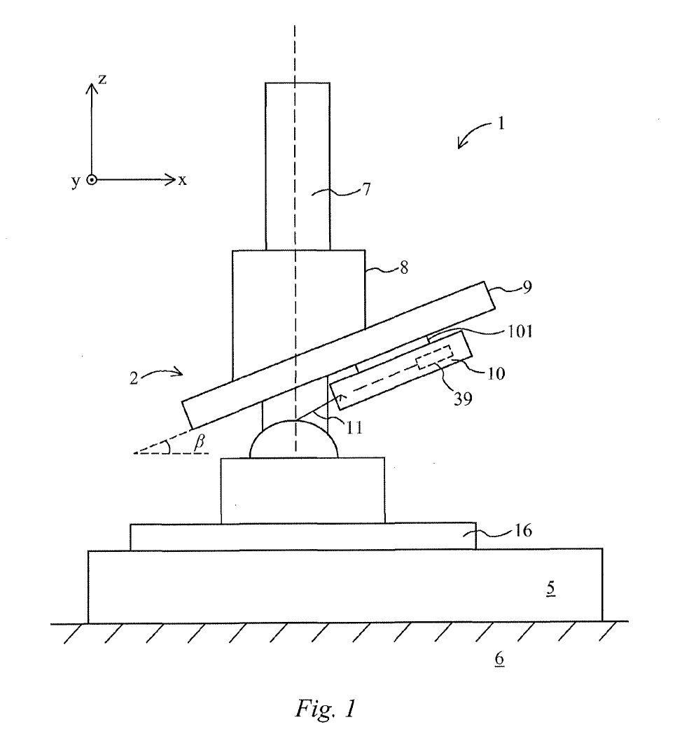

FIG. 1 shows a very schematic representation of a metrological instrument of apparatus embodying the present invention looking in a direction, y, perpendicular to a measurement direction;

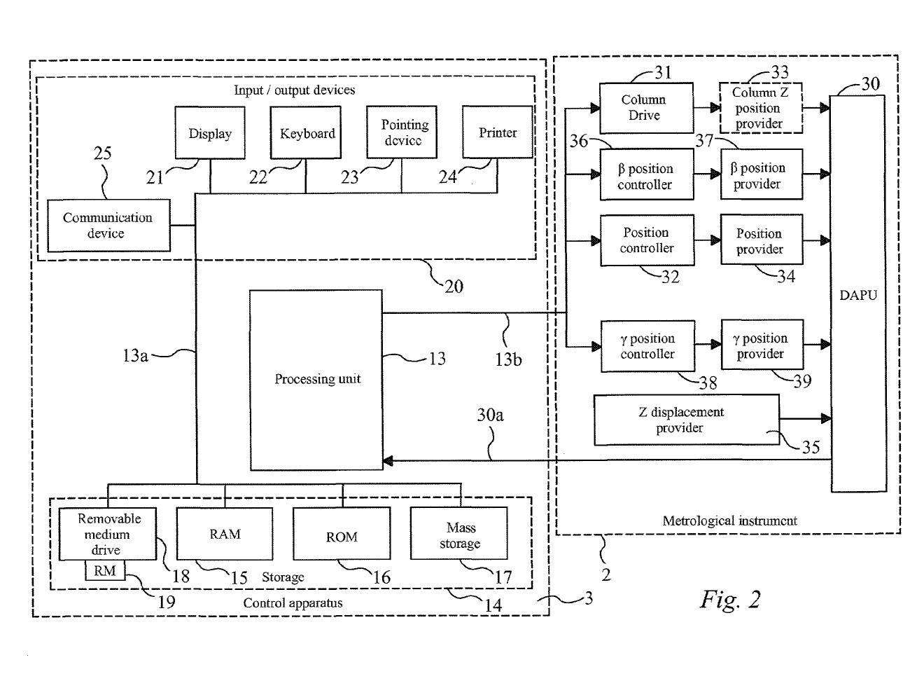

FIG. 2 shows a functional block diagram of data processing and control apparatus of apparatus embodying the present invention;

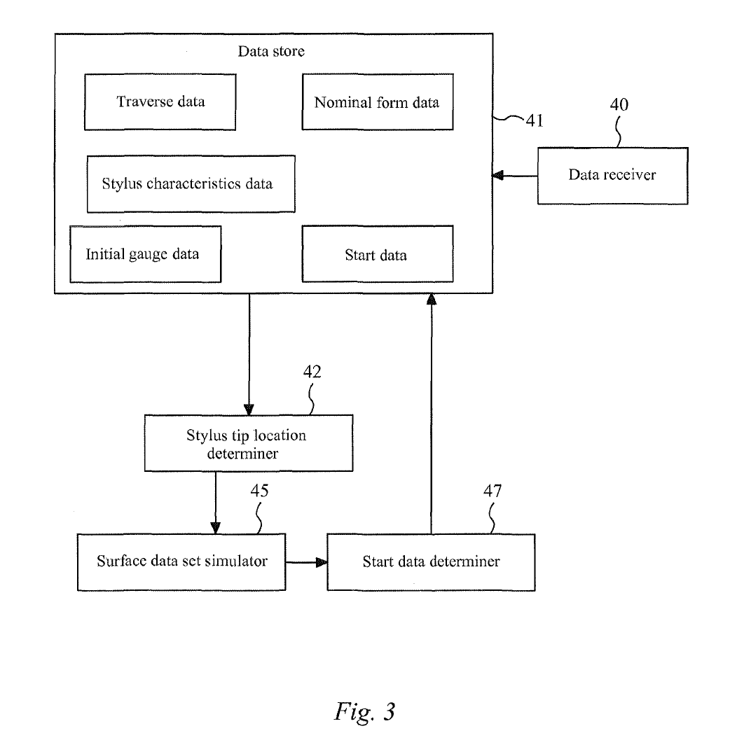

FIG. 3 shows a functional block diagram of setup functionality provided by programming of the control apparatus shown in FIG. 2 for enabling a balanced gauge measurement;

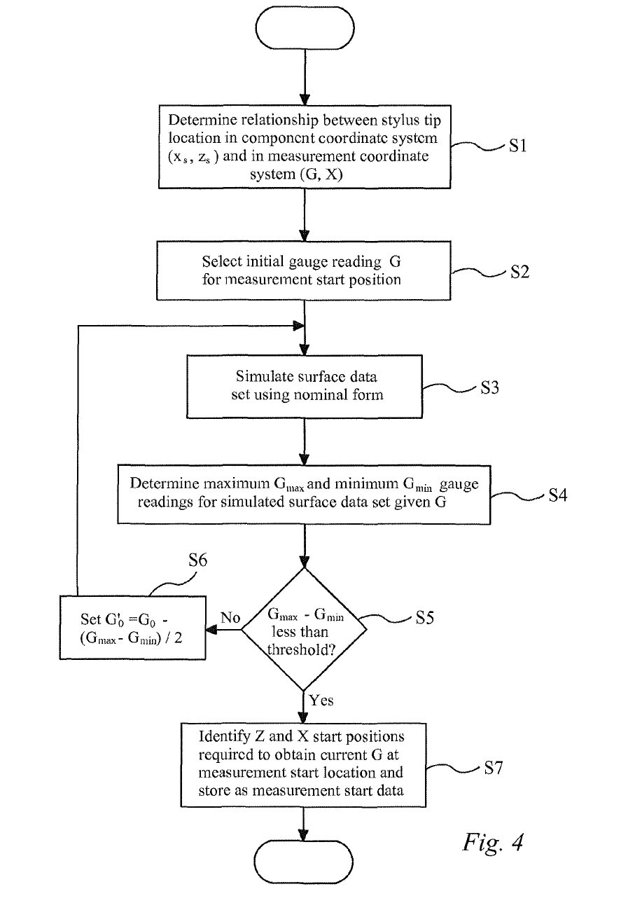

FIG. 4 shows a flow chart illustrating processes for enabling a balanced gauge measurement;

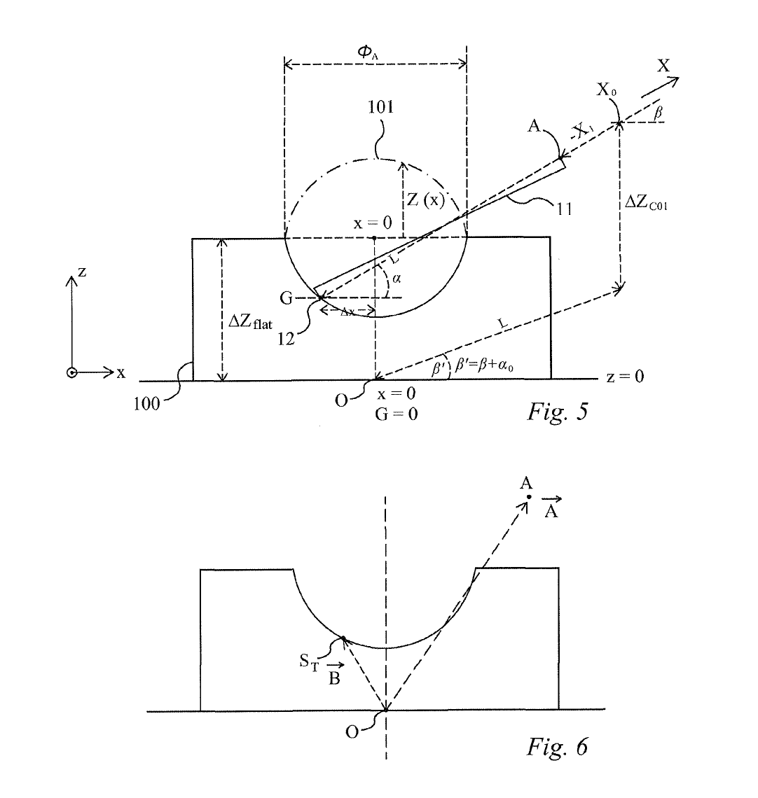

FIGS. 5 to 8 show diagrams for explaining the setup functionality shown in FIGS. 3 and 4; and

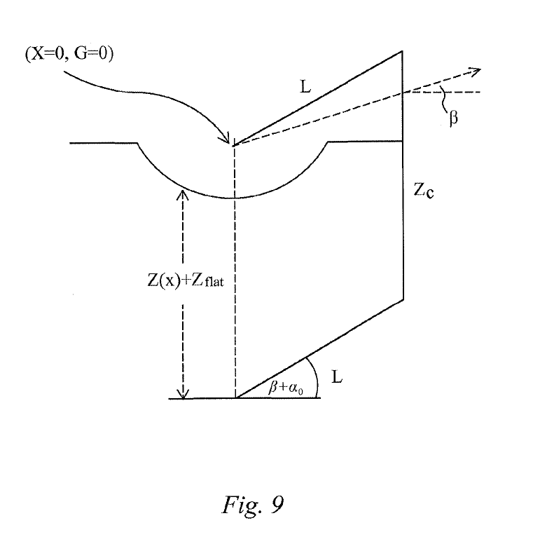

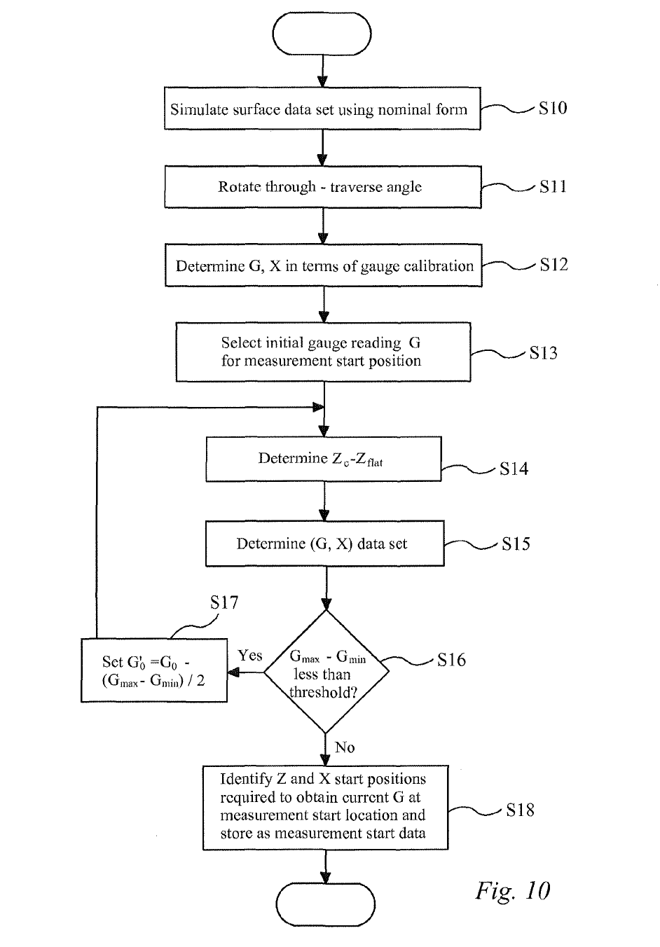

FIGS. 9 and 10 show a diagram and flow chart for explaining another method for enabling a balanced gauge measurement.

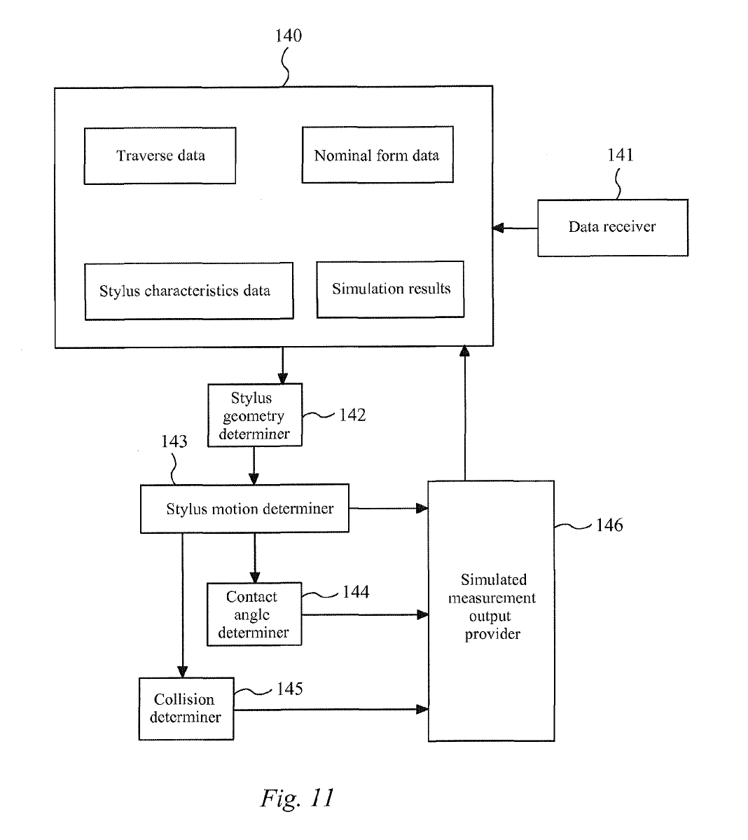

FIG. 11 shows a functional block diagram of functionality provided by programming of the control apparatus shown in FIG. 2 for assisting an operator in correctly setting up the metrological instrument;

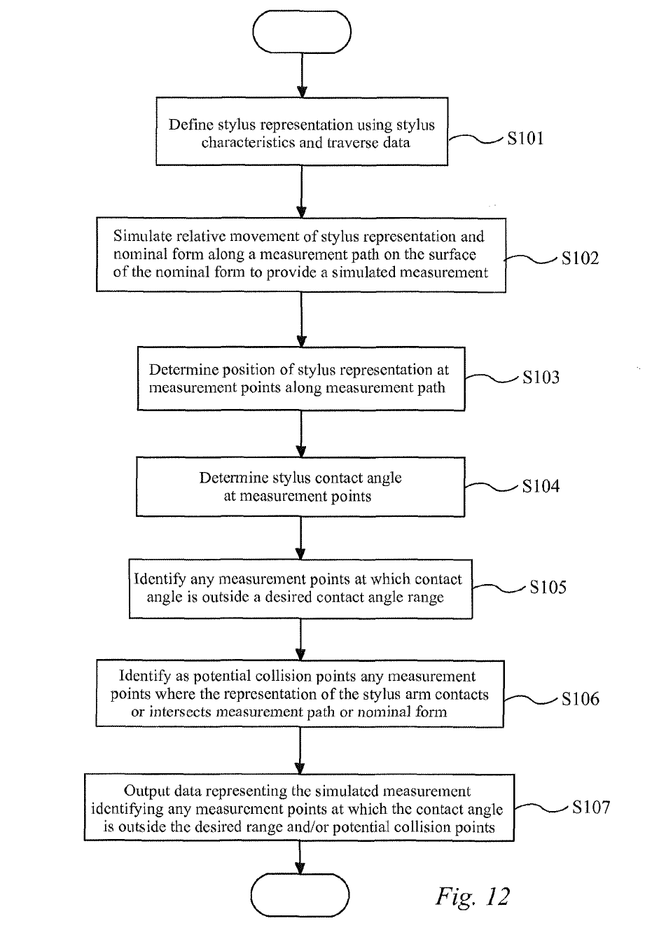

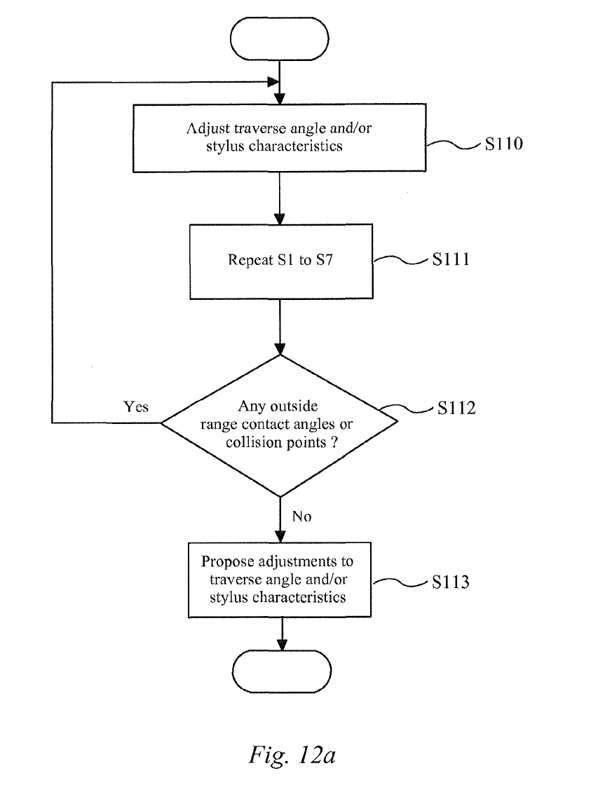

FIG. 12 shows a flow chart illustrating processes for assisting an operator in correctly setting up the metrological instrument;

FIG. 12a shows a flow chart illustrating further processes that may be carried out for assisting an operator in setting up the metrological instrument;

FIGS. 5 to 8 show diagrams for helping to explain the setup functionality shown in FIGS. 11 and 12; and

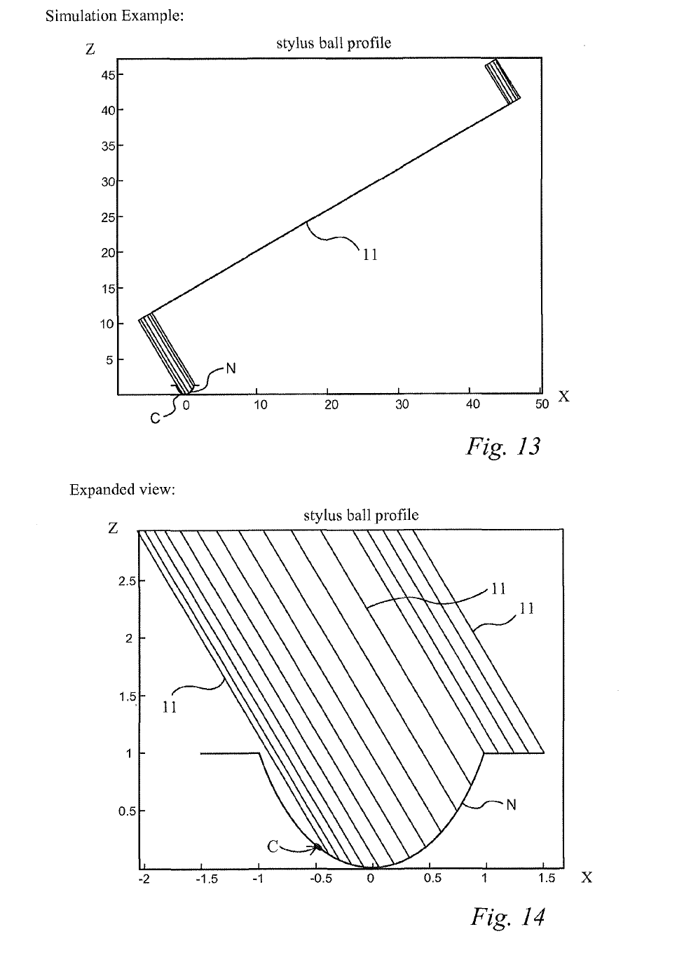

FIGS. 13 to 17 show examples of resulting simulations.

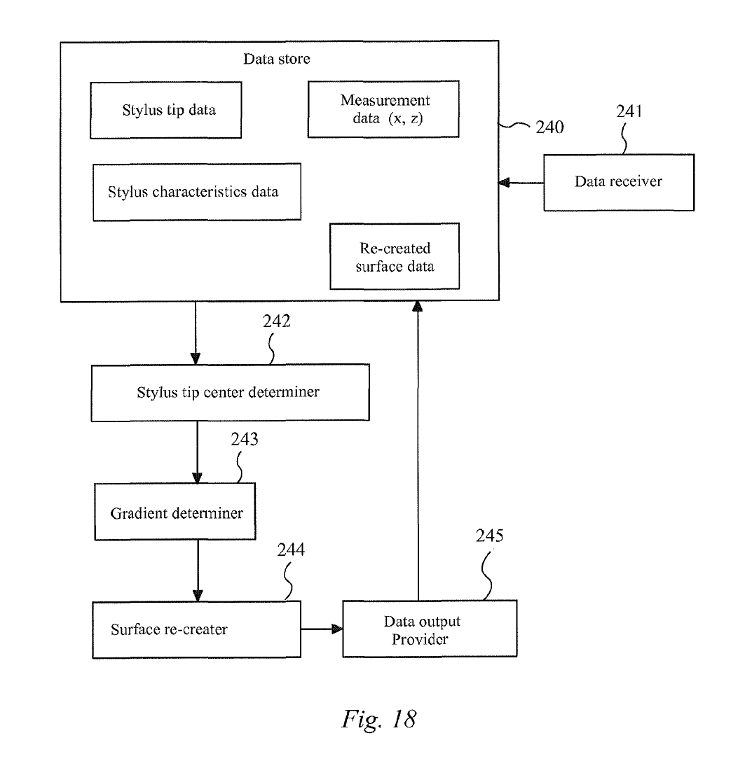

FIG. 18 shows a functional block diagram of functionality provided by programming of the control apparatus shown in FIG. 2 for enabling account to be taken of characteristics of a stylus tip of a stylus of the metrological instrument;

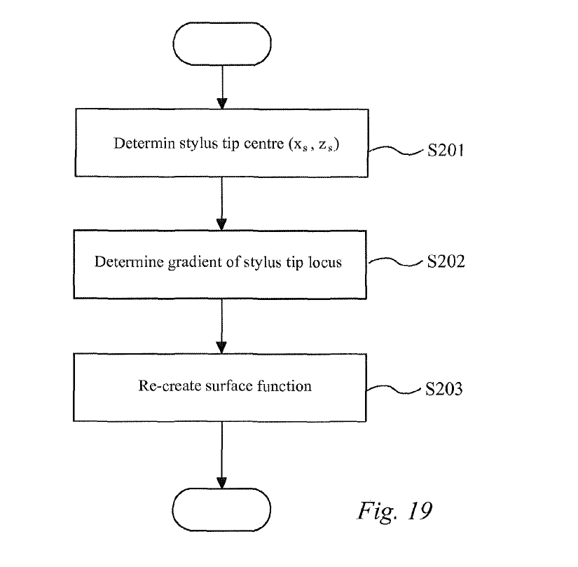

FIG. 19 shows a flow chart illustrating processes for enabling account to be taken of characteristics of a stylus tip of a stylus of the metrological instrument;

FIGS. 5 to 8 show diagrams for explaining a stylus geometry of an example metrological instrument; and

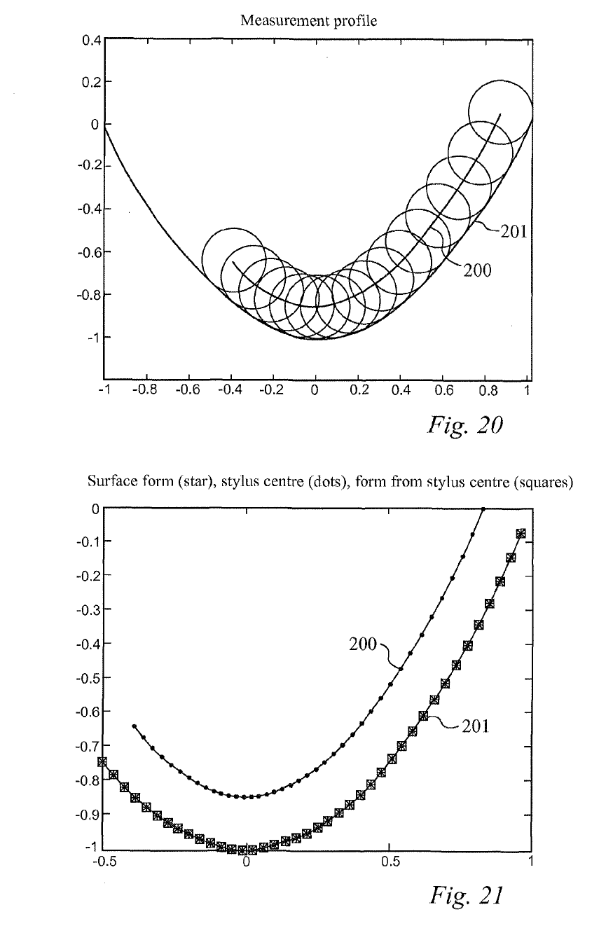

FIG. 20 shows a representation of a locus of the path of the centre of the stylus tip and the surface form being measured; and

FIG. 21 shows a representation of surface form derived from the stylus tip locus shown in FIG. 20.

With reference to the drawings in general, it will be appreciated that the Figures are not to scale and that for example relative dimensions may have been altered in the interest of clarity in the drawings. Also any functional block diagrams are intended simply to show the functionality that exists within the device and should not be taken to imply that each block shown in the functional block diagram is necessarily a discrete or separate entity. The functionality provided by a block may be discrete or may be dispersed throughout the device or throughout a part of the device. In addition, the functionality may incorporate, where appropriate, hard-wired elements, software elements or firmware elements or any combination of these.

Referring now to the drawings, an example metrological apparatus will be described which comprises a metrological instrument and a control apparatus.

FIG. 1 shows a very diagrammatic representation of the metrological instrument 2 of the metrological apparatus 1.

The metrological apparatus 2 has a base 5 that is designed to be supported by a workbench 6. The base 5 carries a column 7 that defines a vertical or z axis reference datum. A column carriage 8 is mounted to the column 7 so as to be movable in the z direction with respect to the column 7. The movement of the column carriage 8 is effected by a motorised drive arrangement (not shown), such as for example a. leadscrew, pulley or other suitable drive arrangement. The base 5 also carries turntable 16 to support a workpiece 14. The turntable 16 has a centring and levelling mechanism (not shown) such as that shown in FIGS. 2 and 3 of GB2,189,604A, the whole contents of which are hereby incorporated by reference.

The column carriage 8 carries a traverse unit 9, which is arranged at an angle β (the transverse angle) to the x-axis (which in the example is represented by the plane of the turntable surface and is generally the horizontal). The transverse unit 9 is movable relative to the column carriage 8 by means of a motorised drive arrangement (not shown) along a straight reference datum (not shown) provided by the traverse unit 9. The direction of this straight reference datum is determined by the orientation of the transverse unit so that the traverse unit 9 is movable in an X direction which extends at the angle β to the x-axis.

The traverse unit 9 carries a measurement probe (or gauge unit) 10 which consists of a pivotally mounted stylus arm (shown very diagrammatically in FIG. 1 in dotted lines within the traverse unit 9) carrying at its free end a stylus arm 11 having a stylus tip 12 which in operation comes into contact with the surface of the workpiece or component under test during a measurement operation so that, as the traverse unit 9 is moved in the measurement direction, the stylus arm 11 pivots to enable the stylus tip 12 to follow surface variations along a measurement path on the surface. Deflection of the stylus arm is detected by a measurement transducer (or displacement provider) 39 shown in dotted lines in FIG. 1. The measurement probe 10 may be mounted to the traverse unit 9 by a y-position adjuster (not shown) so as to be movable in the y-direction with respect to the traverse unit 9. The movement of the measurement probe 10 in the y-direction may be effected by a manual or motorised leadscrew, pulley or other drive arrangement (not shown).

In an example, the traverse unit 9 may be mounted to the column carriage 8 by means of a pivot pin to enable the angle β of the traverse unit 9 with respect to the x-axis to be adjusted. In this particular example, the angle β of the traverse unit 9 is manually adjustable and the traverse unit 9 is held in place at the manually adjusted angle by means of an air brake (not visible in the Figure). As another possibility, the adjustment of the angle β may be automated. As another possibility, the angle β may for some applications be fixed.

FIG. 2 shows a block diagram illustrating functional components of the metrological instrument 2 and the control apparatus 3 of the metrological instrument 1.

Referring now to FIG. 2, the control apparatus 3 is generally a personal computer and has a processing unit 13 coupled via a bus 13a to associated data and program instruction/software storage 14 in the form generally of RAM 15, ROM 16, a mass storage device 17 such as a hard disc drive and at least one removable medium drive 18 for receiving a removable medium (RM) 19, such as a CD-ROM, solid state memory card, DVD, or floppy disc. As another possibility, the removable medium drive may itself be removable, for example it may be an external hard disc drive.

The control apparatus is also coupled via the same or a different bus to input/output devices 20 comprising in this example a display 21, a keyboard 22, a pointing device 23 such as a mouse, a printer 24 and, optionally, a communications device 25 such as at least one of a MODEM and a network card for enabling the control apparatus 3 to communicate signals S via a wired or wireless connection with other control apparatus or computers via a network such as the Internet, an intranet, a WAN or a LAN.

The processing unit 13 is programmed by program instructions and data provided by being at least one of: downloaded as a signal S via the communications device 25; pre-stored in any one or more of ROM 16, RAM 15 and mass storage device 17; read from a removable storage medium 19 received by the removable medium drive 18; and input by the user using the keyboard 22.

The metrological instrument 2 has a data acquisition and processing unit (DAPU) 30 that communicates with the processing unit 13 of the control apparatus 3 via an appropriate link, for example a serial link, 30a to enable data regarding a measurement operation to be communicated to the control apparatus 3.

The control components of the metrological apparatus 2 comprise a column drive controller 31 for driving the carriage 8 up and down the column in the z direction, a measurement direction position controller 32 for driving the measurement probe or gauge unit along the reference datum provided by the traverse unit 9 in the measurement direction X at an angle β to the x-axis and an interferometric z displacement provider 35 for providing a measure of the z displacement of the stylus tip 12 as the stylus arm 11 follows the surface being measured during movement of the traverse unit 9 along a measurement path in a direction at an angle β to the x-axis.

If rotation of the turntable is automated, then the metrological apparatus will also comprise a γ (where γ represents the angle of rotation of the turntable 16 about its spindle axis) position controller 38 for controlling rotation of the turntable 16. Similarly, if the attitude of the traverse unit 9 is adjustable and this adjustment is automated, then a β position controller 36 will be provided for changing the attitude β of the traverse unit 9. γ and β position providers 39, 37 (which may for example be shaft encoders, for example optical shaft encoders, or a linear grating type position provider) are provides to supply signals respectively indicating the angles γ and β to the DAPU 30. Generally the interferometric z displacement provider 35 will be provided within the traverse unit 9.

The measurement direction position controller 32 is associated with a position provider 34 that may be, for example, a shaft encoder associated with a motor providing the position controller 32 or may be a linear grating type of transducer. The column drive 31 may also be associated with a column z position provider 33 (shown in phantom lines in FIG. 2), for example a shaft encoder associated with a motor providing the column drive 31, or the column z position may be determined in an open loop manner directly from the column motor drive signal. As show in FIG. 2, the column drive 31 and position controller 32 (and other controllers if present) are coupled to the control apparatus 3 (via a link 13b and appropriate interfaces, not shown) for control by instructions from the control apparatus 3. At least some of these instructions may be supplied by the user.

The measurement probe or gauge unit is in this example the measurement probe used in the instruments supplied by Taylor Hobson as the Form Talysurf PGI series and is described in detail in U.S. Pat. No. 5,517,307 (the whole contents of which are hereby incorporated by reference) to which reference should be made for further information. In particular the measurement probe or gauge unit may be based on Taylor Hobson's Form Talysurf PGI 1240 metrological instrument, described in the brochure produced by Taylor Hobson entitled “Form Talysurf PGI 1240, Aspherics Measurement system”. This Form Talysurf PGI series of metrological instruments is particularly suited to measuring the surface form of surfaces having significant form because, as described in U.S. Pat. No. 5,517,307, the interferometric z displacement provider 35 uses a curved diffraction grating that has a radius of curvature which is coincident with the axis about which the stylus arm pivots to provide more accurate z displacement measurements over a longer range.

The processing unit is programmed by program instructions to enable carrying out of measurements further details of examples of such programming may be found in WO2010/94306, the whole contents of which are hereby incorporated by reference.

In the following (see FIGS. 5 to 8):

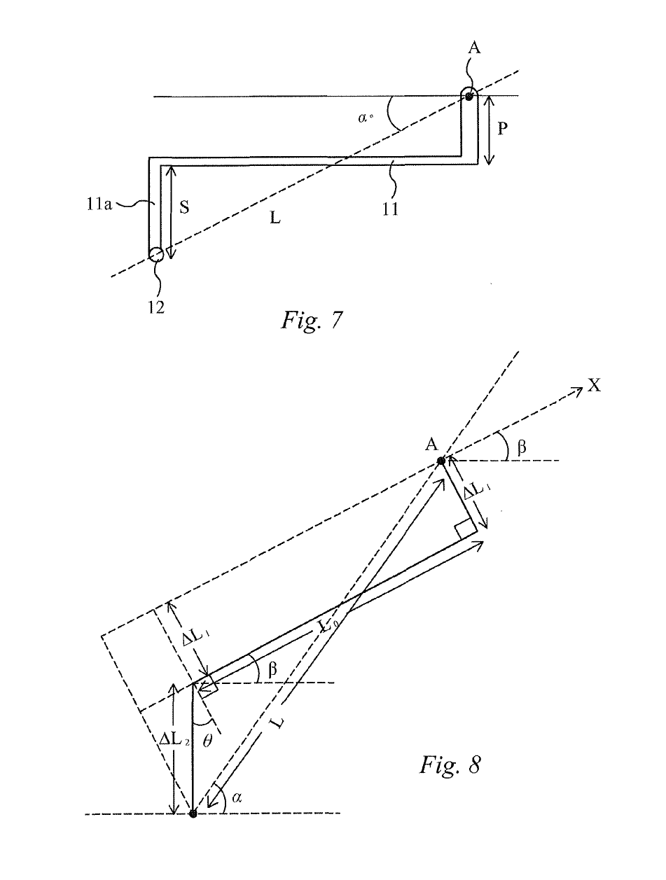

O is the origin, that is the location at which x=0, z=0
Φ_{A} is the nominal base diameter of the workpiece or component whose surface form is to be measured, for example an aspheric lens mould 100 as shown in solid lines in FIG. 5 or an aspheric lens mounted on the attached to a base, the lens being illustrated by the dot-dash line 101 in FIG. 5;
α is the stylus deflection angle between the line passing through the pivot axis A and the centre of the stylus tip 12 and the x axis and represents the degree of deflection of the stylus arm;
G is the gauge reading which as will be explained below is related to the stylus deflection angle α;
β is the angle of the traverse unit to the x axis;
X is the traverse or measurement direction which extends at the angle β to the x axis;
X₁ is the distance the traverse unit has moved in the traverse or measurement direction X from a zero position X₀;
z(x) is the distance in the z direction of a point on the surface being measured from a top surface of the flat part (the body of the mould or the base upon which the aspheric lens is mounted);
Δx is the distance in the x direction of the centre of the stylus tip 12 from x=0 where x=0 corresponds to the turntable spindle axis on which the component to be measured will be centred and aligned, for example as discussed in WO2100/043906, so that a rotational axis of the component (the optical axis in the case of an aspheric lens) is coincident with and aligned to the spindle axis;
ΔZ_{c} or ΔZ_{col} is the distance in the z direction when the stylus tip is at a measurement point on the surface being measured from the corresponding z position at which G=0 (see FIG. 5);
Δz_{flat} is the distance in the z direction from z=0 to the top surface of any flat part, part 100 in FIG. 5;
L₀ is the length of the stylus arm 11;
A is the location of the pivot axis of the stylus arm;
α₀ is the pivot offset angle which as shown in FIG. 7 is an angle between a line parallel to the x axis passing through the pivot axis A and a line passing through the pivot axis A and the centre of the stylus tip 12 with the stylus arm parallel to the traverse axis and is determined, as illustrated in FIG. 7, by the offset P of the pivot axis A from the stylus arm, the length of the stylus arm L and the length S of the stylus shank 11a from the stylus arm to the centre of the stylus tip 12;
L is the distance between the centre of the stylus tip 12 and the pivot axis A, which distance is determined by the length of the stylus arm L, the pivot offset P and the length S of the stylus shank 11a from the stylus arm to the centre of the stylus tip 12.

FIG. 3 shows a functional block diagram illustrating functionality provided by programming of the processor unit to facilitate efficient use of the measurement range of the gauge, such that a measurement of a given surface form (component) exhibits opposite polarity extreme excursions of the same magnitude, that is the measurement is a “balanced gauge” measurement. FIG. 4 shows a flow chart illustrating processes carried out by in order to facilitate a “balanced gauge” measurement whilst FIGS. 5 to 8 are diagrammatic representations of assistance in explaining these processes.

As shown in FIG. 3, the gauge balancing functionality includes a data receiver 40 (which may be provided by the input/output devices shown in FIG. 2) to receive data and store the data in a data store 41 which may be provided by, for example, any one or more of the RAM 15, ROM 16 and/or mass storage 17 shown in FIG. 2. As will be explained below, data stored in the data store 41 includes: initial gauge data G₀; traverse angle (3; a nominal form of the surface of the workpiece to be measured, that is the form that the surface was designed or intended to be and the height Δz_{flat} which as set out above is the distance in the z direction from z=0 to the top surface of the flat part; stylus characteristics data including, for example, the length L of the stylus arm 11, a pivot offset angle α₀, the length S of a stylus shank projecting from the stylus arm 11 and carrying at its free end the stylus tip 12. The data store 41 also provides storage for storing start data determined by the functionality to be described below.

The functionality shown in FIG. 3 includes a stylus tip location determiner 42 for determining a relationship between a stylus tip location (xₛ, zₛ) in a component coordinate system x, z (where xₛ, zₛ represents the location of a centre of a sphere defined by a contact surface of the stylus tip) and a stylus tip location in a measurement coordinate system (G, X) where G represents the gauge data and X₁ represents the position along the traverse direction X, a surface data set simulator 45 for simulating the form of the surface to be measured using the nominal form data in the data store 41, which may be achieved using the stylus tip convolution discussed below, and a start data determiner 47 for determining z and x start positions for the gauge data to facilitate a balanced gauge measurement for the surface form under consideration starting from a given xₛ, zₛ stylus tip measurement start location.

The processes now to be described with reference to FIG. 4 in order to facilitate a balanced gauge measurement may be carried out using the functionality described with reference to FIG. 3 or any other appropriate functionality.

In order to explain the processes shown in FIG. 4, reference should also be made to FIGS. 5 to 8 which illustrate aspects of the geometry of the metrological instrument.

Referring to FIGS. 5 to 8, the vector from origin O to pivot location A in FIG. 6 is given by:

\vec{A}=(L+X₁)(î cos(αₒ+β)+\hat{k} sin(αₒ+β))+\hat{k}ΔZ_{col} 1)

where î and \hat{k} are the unit vectors in the x and z directions.

(In the example illustrated in FIG. 5 the traverse unit has been driven in the negative X direction from X₀ and so X₁ has a negative value.)

The vector \vec{B} from origin O to the stylus tip centre in FIG. 6 is given by:

\vec{A}−L(î cos α+\hat{k} sin α)=îΔx+\hat{k}(ΔZ_{flat}+Z(Δx))≡îΔxₛ+\hat{k}zₛ 2)

The gauge reading G and its relationship with the stylus deflection angle α are given by:

G=+L(αₒ+β−α) [symbol] α=αₒ+β−(G/L) 3)

Extracting the orthogonal components (x,z) from equations 1 and 2 allows a pair of relationships to be defined that relate the stylus tip centre values (xₛ,zₛ) in terms of the stylus and instrument parameters as follows:

L cos(β+αₒ)+X cos β−L cos α=xₛ 4)

L sin(β+αₒ)+X sin β+ΔZ_{col}−L sin α=zₛ 4)

Data representing the nominal form of the component to be measured may be input by the operator but may be pre-stored. Again, the data store may store data representing various different nominal surface forms for selection by the user.

FIGS. 7 and 8 in particular show the geometry and dimensions of the stylus. This data is either pre-stored or input by the operator. Where a number of different styli are available, the operator may select the stylus characteristics data form a number of pre-stored sets of stylus characteristics data. As another possibility, the stylus itself may carry the data in a local non-volatile memory or may carry identification data identifying the stylus so that the control apparatus can select the correct set of stylus data from its data store. In this example, the stylus data includes the length L₀ is of the stylus arm 11, the pivot offset angle α₀ which as shown in FIG. 7 is an angle between a line parallel to the x axis passing through the pivot axis A and a line passing through the pivot axis A and the centre of the stylus tip 12 with the stylus arm parallel to the traverse axis and is determined, as illustrated in FIG. 7, by the offset P of the pivot axis A from the stylus arm, the length of the stylus arm L and the length S of the stylus shank 11a from the stylus arm to the centre of the stylus tip 12, and the length S of the stylus shank 11a from the stylus arm to the centre of the stylus tip 12.

The traverse angle β will generally be input by the operator but could be determined by detecting the degree of rotation using an appropriate transducer. The measurement step Xᵢ may be pre-defined but could be operator-selectable.

The stylus characteristics data also includes the geometry and dimensions of the stylus tip. In this example, the stylus tip is in the form of a sphere of given radius r. The centre of that sphere will not coincide with the point on the stylus tip that contacts the surface being measured. If the nominal form of the component to be measured is represented as z(x) then it has a gradient of

$$\frac{d z}{d x} = tan Ψ .$$

For a stylus tip of radius r traversing this surface, the tip centre is then defined by

zₛ=z+r cos ψ

xₛ=x−r sin ψ 5)

where the point of contact between the stylus tip and the surface is (x, z). These stylus tip centre values (xₛ, zₛ) are used throughout the following.

In order to determine α (and so G), Zc and X, the equations 4) above may be inverted to yield:

$${Z}_{c} - {Z}_{flat} = \frac{L ( sin ( α - β ) - sin {α}_{o} ) - {x}_{s} sin β + {z}_{s} cos β}{cos β} \\ X = \frac{L ( cos α - cos ( β + {α}_{o} ) ) + {x}_{s}}{cos β} \qquad 6 )$$

At S1 in FIG. 4, equation 6) is used to determine the relationship between the stylus tip location (xₛ, zₛ) in the component coordinate system (x, z) and in the measurement system (G,X). The stylus and instrument parameters αₒ, β and L may be pre-stored f they are fixed for the instrument but will generally be input by the operator via the data receiver during the set up procedure prior to starting a measurement operation for a particular surface form. As another possibility, the data store may store various different stylus and instrument parameters and the operator may select the parameters appropriate for the selected stylus and traverse angle.

An initial gauge reading for a measurement start position is determined at S2 and a simulated surface data set is determined at S3, using the stylus tip convolution discussed above (with reference to FIG. 4). Now considering simulating the measurement of (xₛ, zₛ), if the gauge signal at the beginning of the measurement simulation (Go) is set at, say, zero at S2, then since α=αₒ+β−(G/L) generally, this inverted equation may be solved for X and Z_{c}-Z_{flat}. The original main equation pair 4) may also be usefully inverted to yield (G, X) in terms of (xₛ, zₛ):

$$\begin{matrix}{X}_{\pm } = \frac{- B \pm \sqrt{{B}^{2} - 4 C}}{2} \\ where \\ B = 2 ( L cos {α}_{o} + ( {Z}_{c} - z ) sin β - {x}_{s} cos β ) \\ C = ( \begin{matrix}{x}^{2} - 2 Lx cos ( β + {α}_{o} ) + \\ 2 L ( {Z}_{c} - {z}_{s} ) sin ( β + {α}_{o} ) + {( {Z}_{c} - {z}_{s} )}^{2}\end{matrix} ) \\ and & 7 ) \\ α = {tan}^{- 1} ( \frac{L sin ( β + {α}_{o} ) + X sin β + ( {Z}_{c} - {z}_{s} )}{L cos ( β + {α}_{o} ) + X cos β + {x}_{s}} ) & 8 )\end{matrix}$$

The simulation selects the most appropriate one of the two solutions for X. In this example, for the data pair adjacent to the first (xₛ,zₛ) data pair, the correct solution for X is chosen to be the one that is closest to the original X value. This enables the determination of a and hence G for the simulated surface form data set. The process of comparing the two possible solutions for the j^{th} value of X with the known (j−1)^{th} value enables the entire data set to be analysed to determine a set of values for G for the simulated surface form data set.

The maximum and minimum values of G, Gₘₐₓ and Gₘᵢₙ, in the determined set of values for G are then identified at S4 and, if at S5 the difference between the magnitudes |Gₘₐₓ| and |Gₘᵢₙ| is not below a determined threshold (which may be pre-set or defined by the operator), Gₒ is updated at S6 to be:

Gₒ=Gₒ−(Gₘₐₓ−Gₘᵢₙ)/2 9)

and S3 and S4 repeated.

When the difference between |Gₘₐₓ| and |Gₘᵢₙ| is determined at S5 to be below the threshold, this iterative process is halted, at which point the starting values for both X and G will have been determined. Once these are known then Z_{c}-Z_{flat} can be determined and the values of z and X required for the measurement start position to achieve a balanced gauge measurement stored so that, once the operator has completed the initial centring and levelling procedures and inputs a command to the control apparatus to start a measurement, then the control apparatus can drive the carriage 8 and the traverse unit 9 to the z and X positions to achieve a balanced gauge measurement. This should facilitate more accurate measurement and also should speed up the measurement process because the operator does not have to try to determine the best z and X starting positions by trial and error something which would be a time-consuming procedure because generally there may be more than one combination of z and X that results in a given stylus angle α. The described process is particularly advantageous where the traverse unit extends at an angle to the x axis because, in those circumstances, the relationship between the gauge signal G and z and X is not intuitive or straightforward and so it is even more difficult for the operator to try to determine, by trial and error, a starting value for G to achieve a balanced gauge measurement.

Another way of facilitating a balanced gauge measurement using calibration coefficients of the gauge will now be described with the aid of FIG. 9 which shows a diagram of a geometrical representation of part of the stylus and traverse geometry and FIG. 10 which shows a flow chart illustrating the process.

At S10 in FIG. 10, the nominal surface form or profile is simulated and at S11 this nominal surface form or profile is rotated to lie in the frame of reference of the stylus by rotation by −β (-traverse angle) about the location (0, Z_{c}) so as to lie in the frame of reference of the stylus. So, for brevity referring to the nominal profile as z(x)+z_{flat}:

$$( \begin{matrix}{x}_{G} \\ {z}_{G}\end{matrix} ) = ( \begin{matrix}cos ( - β ) & - sin ( β ) \\ sin ( - β ) & cos ( - β )\end{matrix} ) ( \begin{matrix}{x}_{s} \\ {z}_{s} ( {x}_{s} ) - ( {Z}_{c} - {Z}_{flat} )\end{matrix} ) \qquad 10 )$$

The gauge (transducer 39 in FIG. 1) has gauge calibration relationships given by:

z_{G}=α₁G+α₂G²+α₃G³

x_{G}=X+β₁z_{G}+β₂z_{G}²+β₃z_{G}³ 11)

The relationship for z_{G} may be inverted by a least-mean squares approach and the relationship for x_{G} may be simply re-expressed to give, at S12:

G=γ₁z_{G}+γ₂z_{G}²+γ₃z_{G}³

X=x_{G}−(β₁z_{G}+β₂z_{G}²+β₃z_{G}³) 12)

These relationships may be pre-stored from an earlier gauge calibration so that data representing G and X on the basis of the gauge calibrations is provided with the measurement apparatus or may be calculated when the gauge is calibrated by an operator.

The subsequent procedure is similar to that shown in FIG. 4 in that the gauge signal is set to zero at S13 in FIG. 10 for the start of the (xₛ,zₛ) data. This, as discussed above, defines α and so enables a starting value for Z_{c}−Z_{flat} to be determined at S14 in accordance with equation 6. The corresponding (G, X) data set is then determined at S15 in accordance with equations 10 and 12.

Assuming that the threshold criterion at S16 is not met, then a new starting value for G (Gₒ) is determined at S17 as before in accordance with equation 9 and at S14 the equivalent α is determined from equation 3 and an updated value for Z_{c}.-Z_{flat} generated in accordance with equation 6 from which an updated (G, X) data set is determined at S15. S14 to S17 are repeated until the difference between the magnitudes |Gₘₐₓ| and |Gₘᵢₙ| is below a threshold at which point the starting values for both X and G to provide a balanced gauge measurement have been determined. Once these are known then Z_{c}-Z_{flat} can be determined and the values of z and X required for the measurement start position to achieve a balanced gauge measurement stored so that, once the operator has completed the initial centring and levelling procedures and inputs a command to the control apparatus to start a measurement, then the control apparatus can drive the carriage 8 and the traverse unit 9 to the z and X positions to achieve a balanced gauge measurement. As before, this should facilitate more accurate measurement and also should speed up the measurement process because the operator does not have to try to determine the best z and X starting positions by trial and error something which would be a time-consuming procedure because there may be more than one combination of z and X that results in a given stylus angle α. The described process is particularly advantageous where the traverse unit extends at an angle to the x axis because, in those circumstances, the relationship between the gauge signal G and z and X is not intuitive or straightforward and so it is even more difficult for the operator to try to determine, by trial and error, at a starting value for G to achieve a balanced gauge measurement.

Subsequent measurements may be carried out in known manner, for example as discussed in WO 2010/043906, the whole contents of which are hereby incorporated by reference.

Referring now to FIGS. 1, 2, 5, 6, 7, 8 and 11 to 17, an example metrological apparatus will be described which comprises a metrological instrument and a control apparatus.

FIG. 1 shows a very diagrammatic representation of the metrological instrument 2 of the metrological apparatus 1.

The metrological apparatus 2 has a base 5 that is designed to be supported by a workbench 6. The base 5 carries a column 7 that defines a vertical or z axis reference datum. A column carriage 8 is mounted to the column 7 so as to be movable in the z direction with respect to the column 7. The movement of the column carriage 8 is effected by a motorised drive arrangement (not shown), such as for example a. leadscrew, pulley or other suitable drive arrangement. The base 5 also carries turntable 16 to support a workpiece 14. The turntable 16 has a centring and levelling mechanism (not shown) such as that shown in FIGS. 2 and 11 of GB2,189,604A, the whole contents of which are hereby incorporated by reference.

The column carriage 8 carries a traverse unit 9, which is arranged at an angle β (the transverse angle) to the x-axis (which in the example is represented by the plane of the turntable surface and is generally the horizontal). The transverse unit 9 is movable relative to the column carriage 8 by means of a motorised drive arrangement (not shown) along a straight reference datum (not shown) provided by the traverse unit 9. The direction of this straight reference datum is determined by the orientation of the transverse unit so that the traverse unit 9 is movable in an X direction which extends at the angle β to the x-axis.

The traverse unit 9 carries a measurement probe (or gauge unit) 10 which consists of a pivotally mounted stylus arm (shown very diagrammatically in FIG. 1 in dotted lines within the traverse unit 9) carrying at its free end a stylus arm 11 having a stylus tip 12 which in operation comes into contact with the surface of the workpiece or component under test during a measurement operation so that, as the traverse unit 9 is moved in the measurement direction, the stylus arm 11 pivots to enable the stylus tip 12 to follow surface variations along a measurement path on the surface. Deflection of the stylus arm is detected by a measurement transducer (or displacement provider) 39 shown in dotted lines in FIG. 1. The measurement probe 10 may be mounted to the traverse unit 9 by a y-position adjuster (not shown) so as to be movable in the y-direction with respect to the traverse unit 9. The movement of the measurement probe 10 in the y-direction may be effected by a manual or motorised leadscrew, pulley or other drive arrangement (not shown).

In an example, the traverse unit 9 may be mounted to the column carriage 8 by means of a pivot pin to enable the angle β of the traverse unit 9 with respect to the x-axis to be adjusted. In this particular example, the angle β of the traverse unit 9 is manually adjustable and the traverse unit 9 is held in place at the manually adjusted angle by means of an air brake (not visible in the Figure). As another possibility, the adjustment of the angle β may be automated. As another possibility, the angle β may for some applications be fixed.

FIG. 2 shows a block diagram illustrating functional components of the metrological instrument 2 and the control apparatus 3 of the metrological instrument 1.

Referring now to FIG. 2, the control apparatus 3 is generally a personal computer and has a processing unit 13 coupled via a bus 13a to associated data and program instruction/software storage 14 in the form generally of RAM 15, ROM 16, a mass storage device 17 such as a hard disc drive and at least one removable medium drive 18 for receiving a removable medium (RM) 19, such as a CD-ROM, solid state memory card, DVD, or floppy disc. As another possibility, the removable medium drive may itself be removable, for example it may be an external hard disc drive.

The control apparatus is also coupled via the same or a different bus to input/output devices 20 comprising in this example a display 21, a keyboard 22, a pointing device 23 such as a mouse, a printer 24 and, optionally, a communications device 25 such as at least one of a MODEM and a network card for enabling the control apparatus 3 to communicate signals S via a wired or wireless connection with other control apparatus or computers via a network such as the Internet, an intranet, a WAN or a LAN.

The processing unit 13 is programmed by program instructions and data provided by being at least one of: downloaded as a signal S via the communications device 25; pre-stored in any one or more of ROM 16, RAM 15 and mass storage device 17; read from a removable storage medium 19 received by the removable medium drive 18; and input by the user using the keyboard 22.

The metrological instrument 2 has a data acquisition and processing unit (DAPU) 30 that communicates with the processing unit 13 of the control apparatus 3 via an appropriate link, for example a serial link, 30a to enable data regarding a measurement operation to be communicated to the control apparatus 3.

The control components of the metrological apparatus 2 comprise a column drive controller 31 for driving the carriage 8 up and down the column in the z direction, a measurement direction position controller 32 for driving the measurement probe or gauge unit along the reference datum provided by the traverse unit 9 in the measurement direction X at an angle β to the x-axis and an interferometric z displacement provider 35 for providing a measure of the z displacement of the stylus tip 12 as the stylus arm 11 follows the surface being measured during movement of the traverse unit 9 along a measurement path in a direction at an angle β to the x-axis.

If rotation of the turntable is automated, then the metrological apparatus will also comprise a γ (where γ represents the angle of rotation of the turntable 16 about its spindle axis) position controller 38 for controlling rotation of the turntable 16. Similarly, if the attitude of the traverse unit 9 is adjustable and this adjustment is automated, then a β position controller 36 will be provided for changing the attitude β of the traverse unit 9. γ and β position providers 39, 37 (which may for example be shaft encoders, for example optical shaft encoders, or a linear grating type position provider) are provides to supply signals respectively indicating the angles γ and β to the DAPU 30. Generally the interferometric z displacement provider 35 will be provided within the traverse unit 9.

The measurement direction position controller 32 is associated with a position provider 34 that may be, for example, a shaft encoder associated with a motor providing the position controller 32 or may be a linear grating type of transducer. The column drive 31 may also be associated with a column z position provider 33 (shown in phantom lines in FIG. 2), for example a shaft encoder associated with a motor providing the column drive 31, or the column z position may be determined in an open loop manner directly from the column motor drive signal. As show in FIG. 2, the column drive 31 and position controller 32 (and other controllers if present) are coupled to the control apparatus 3 (via a link 13b and appropriate interfaces, not shown) for control by instructions from the control apparatus 3. At least some of these instructions may be supplied by the user.

The measurement probe or gauge unit is in this example the measurement probe used in the instruments supplied by Taylor Hobson as the Form Talysurf PGI series and is described in detail in U.S. Pat. No. 5,517,307 (the whole contents of which are hereby incorporated by reference) to which reference should be made for further information. In particular the measurement probe or gauge unit may be based on Taylor Hobson's Form Talysurf PGI 1240 metrological instrument, described in the brochure produced by Taylor Hobson entitled “Form Talysurf PGI 1240, Aspherics Measurement system”. This Form Talysurf PGI series of metrological instruments is particularly suited to measuring the surface form of surfaces having significant form because, as described in U.S. Pat. No. 5,517,307, the interferometric z displacement provider 35 uses a curved diffraction grating that has a radius of curvature which is coincident with the axis about which the stylus arm pivots to provide more accurate z displacement measurements over a longer range.

The processing unit is programmed by program instructions to enable carrying out of measurements further details of examples of such programming may be found in WO2010/943906, the whole contents of which are hereby incorporated by reference.

In the following (see FIGS. 5 to 8):

O is the origin, that is the location at which x=0, z=0
Φ_{A} is the nominal base diameter of the workpiece or component whose surface form is to be measured, for example an aspheric lens mould 100 as shown in solid lines in FIG. 5 or an aspheric lens mounted on the attached to a base, the lens being illustrated by the dot-dash line 101 in FIG. 5;
α is the stylus deflection angle between the line passing through the pivot axis A and the centre of the stylus tip 12 and the x axis and represents the degree of deflection of the stylus arm;
G is the gauge reading which is related to the stylus deflection angle α;
β is the angle of the traverse unit to the x axis;
X is the traverse or measurement direction which extends at the angle β to the x axis;
X₁ is the distance the traverse unit has moved in the traverse or measurement direction X from a zero position X₀;
z(x) is the distance in the z direction of a point on the surface being measured from a top surface of the flat part (the body of the mould or the base upon which the aspheric lens is mounted);
Δx is the distance in the x direction of the centre of the stylus tip 12 from x=0 where x=0 corresponds to the turntable spindle axis on which the component to be measured will be centred and aligned, for example as discussed in WO2100/043906, so that a rotational axis of the component (the optical axis in the case of an aspheric lens) is coincident with and aligned to the spindle axis;
ΔZ_{c} or ΔZ_{col} is the distance in the z direction when the stylus tip is at a measurement point on the surface being measured from the corresponding z position at which G=0 (see FIG. 5);
Δz_{flat} is the distance in the z direction from z=0 to the top surface of any flat component part, part 100 in FIG. 5;
L₀ is the length of the stylus arm 11;
A is the location of the pivot axis of the stylus arm;
α₀ is the pivot offset angle which as shown in FIG. 7 is an angle between a line parallel to the x axis passing through the pivot axis A and a line passing through the pivot axis A and the centre of the stylus tip 12 with the stylus arm parallel to the traverse axis and is determined, as illustrated in FIG. 7, by the offset P of the pivot axis A from the stylus arm, the length of the stylus arm L and the length S of the stylus shank 11a from the stylus arm to the centre of the stylus tip 12;
L is the distance between the centre of the stylus tip 12 and the pivot axis A, which distance is determined by the length of the stylus arm L, the pivot offset P and the length S of the stylus shank 11a from the stylus arm to the centre of the stylus tip 12.

FIG. 11 shows a functional block diagram illustrating functionality provided by programming of the processor unit to assist an operator in setting up the metrological instrument so as to avoid or at least reduce the possibility of an out-of-range contact angle or a collision between the stylus arm and component or workpiece under test.

As shown in FIG. 11, the set up assistance functionality includes a data receiver 141 (which may be provided by the input/output devices shown in FIG. 2) to receive data and store the data in a data store 140 which may be provided by, for example, any one or more of the RAM 15, ROM16 and/or mass storage 17 shown in FIG. 2. As will be explained below, data stored in the data store 140 includes: traverse data including the traverse angle β and the measurement step X, in the traverse direction; a nominal form of the surface of the workpiece to be measured, that is the form that the surface was designed or intended to have, and the height Δz_{flat} which as set out above is the distance in the z direction from z=0 to the top surface of the flat part 100; stylus characteristics including, for example, the length L of the stylus arm 11, a pivot offset angle α₀, the length S of a stylus shank projecting from the stylus arm 11 and carrying at its free end the stylus tip 12 and the dimensions and geometry of the stylus tip. The data store 140 also provides storage for simulation results.

The functionality shown in FIG. 11 includes: a stylus geometry determiner 142 that uses the stylus characteristics to define a geometrical representation of the stylus; a stylus motion determiner 143 that uses the geometrical representation of the stylus, the nominal form and the traverse data to determine what the position and orientation of that stylus arm would be at each measurement point Xᵢ as the stylus tip follows a measurement path on a surface of the nominal form; a contact angle determiner 144 to determine the contact angle of the stylus tip at each measurement point using the determined position and orientation of that stylus arm at each measurement point Xᵢ and the known the dimensions and geometry of the stylus tip; a collision determiner 145 to determine the possibility of a collision between the stylus arm and the workpiece or component at each measurement point using the determined position and orientation of the stylus arm at each measurement point and the nominal form; and a simulated measurement output provider for outputting the simulation results to a resource such as a display, printer, network connection or another computer with any measurement points with out-of-range contact angles or collisions between the stylus arm and the workpiece or component highlighted, for example displayed or printed in another colour such as red.

Processes will now to be described with reference to FIGS. 12 and 12a that may assist an operator in setting up the metrological instrument to avoid or reduce the possibility of out-of-range contact angles or collisions. These processes may be carried out using the functionality described with reference to FIG. 11 or any other appropriate functionality.

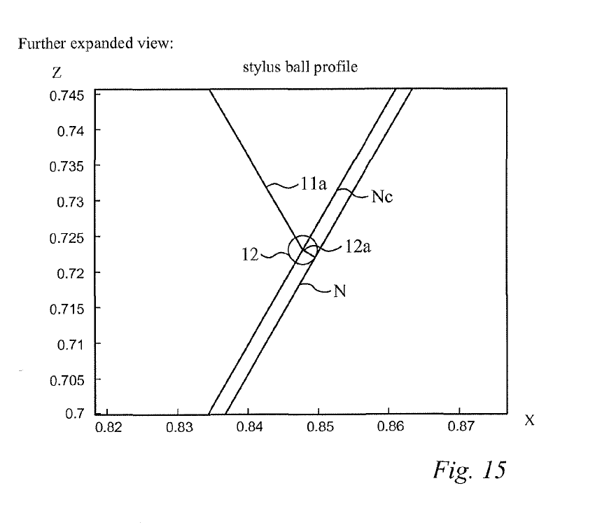

In order to explain the processes shown in FIGS. 12 and 12a, reference is made to FIGS. 15 to 18 which illustrate aspects of the geometry of the metrological instrument.

Referring to FIGS. 5 to 8, the vector from origin O to pivot location A in FIG. 6 is given by:

\vec{A}=(L+X₁)(î cos(αₒ+β)+\hat{k} sin(αₒ+β))+\hat{k}ΔZ_{col} 13)

where î and \hat{k} are the unit vectors in the x and z directions.

(In the example illustrated in FIG. 5 the traverse unit has been driven in the negative X direction from X₀ and so X₁ has a negative value.)

The vector \vec{B} from origin O to the stylus tip centre in FIG. 6 is given by:

\vec{A}L(î cos α+\hat{k} sin α)=îΔx+\hat{k}(ΔZ_{flat}+Z(Δx))≡îΔxₛ+\hat{k}zₛ 14)

The gauge reading G and its relationship with the stylus deflection angle α are given by:

G=L(αₒ+β−α) [symbol] α=αₒβ−(G/L) 15)

Extracting the orthogonal components (x,z) from equations 13 and 14 allows a pair of relationships to be defined that relate the stylus tip centre values (xₛ,zₛ) in terms of the stylus and instrument parameters as follows:

L cos(β+αₒ)+X cos β−L cos α=xₛ

L sin(β+αₒ)+X sin β+ΔZ_{col}−L sin α=zₛ 16)

FIGS. 7 and 8 in particular show the geometry and dimensions of the stylus. This data is either pre-stored or input by the operator. Where a number of different styli are available, the operator may select the stylus characteristics data from a number of pre-stored sets of stylus characteristics data. As another possibility, the stylus itself may carry the data in a local non-volatile memory or may carry identification data identifying the stylus so that the control apparatus can select the correct set of stylus data from its data store.

In this example, the stylus data includes the length L₀ of the stylus arm 11, the pivot offset angle α₀ which as shown in FIG. 7 is an angle between a line parallel to the x axis passing through the pivot axis A and a line passing through the pivot axis A and the centre of the stylus tip 12 with the stylus arm parallel to the traverse axis and is determined, as illustrated in FIG. 7, by the offset P of the pivot axis A from the stylus arm, the length of the stylus arm L₀ and the length S of the stylus shank 11a from the stylus arm to the centre of the stylus tip 12, and the length S of the stylus shank 11a from the stylus arm to the centre of the stylus tip 12. The stylus characteristics data also includes the geometry and dimensions of the stylus tip. In this example, the stylus tip is in the form of a sphere of given radius r.

The traverse angle β will generally be input by the operator but could be determined by detecting the degree of rotation using an appropriate transducer as discussed above. The measurement step Xᵢ may be pre-defined but could be operator-selectable.

Data representing the nominal form of the component to be measured may be input by the operator but may be pre-stored. Again, the data store may store data representing various different nominal surface forms for selection by the user.

If the nominal form of the component to be measured is represented as z(x) then it has a gradient of

$$\frac{d z}{d x} = tan Ψ .$$

For a stylus tip of radius r traversing this surface, the tip centre is then defined by

zₛ=z+r cos ψ

xₛ=x−r sin ψ 17)

where the point of contact between the stylus tip and the surface is (x, z). These stylus tip centre values (xₛ, zₛ) are used throughout the following.

In order to determine α (and so G), Zc and X, equation 16) above may be inverted to yield:

$${Z}_{c} - {Z}_{flat} = \frac{L ( sin ( α - β ) - sin {α}_{o} ) - {x}_{s} sin β + {z}_{s} cos β}{cos β} \\ X = \frac{L ( cos α - cos ( β + {α}_{o} ) ) + {x}_{s}}{cos β} \qquad 18 )$$

At S101 in FIG. 12, a stylus representation is defined using the stylus characteristics and the traverse data. This stylus representation represents the stylus geometry and orientation in relation to the nominal form. The stylus representation and the nominal surface are for convenience represented in the same coordinate space, either that of the nominal surface, that is (x, z) or the measurement coordinate space (G (or a), X), in accordance with the relationships set out in equation 18.

At S102, relative movement between the stylus representation and the nominal form along the measurement direction X with the stylus tip following the nominal form is simulated to provide a simulated measurement and at S103 the relative positions of the stylus and the nominal form are determined at each measurement point.

At S104 the contact angle between the stylus and the nominal form is determined for each measurement point. In this example, the contact angle is determined to be the angle between the normal to the local nominal form gradient or tangent and the stylus shank direction or axis at the measurement point so that when the stylus shank is perpendicular to the local gradient at a measurement point the contact angle for that measurement point is zero. Other ways of defining the contact angle are possible.

At S105 any measurement points for which the contact angle is out of a desired range, for example exceeds a threshold, is identified. At S106, a determination is made at each measurement point as to whether any part of the stylus representation other than the stylus tip (that is the stylus arm or shank, for example) contacts or intersects the nominal form and if so that measurement point is identified as a potential collision point. It will of curse be understood that S106 could be carried out before S104 and/or S105.

At S107 the resulting data is output to a resource such as a display or printer of the input/output devices of FIG. 2 or to the communication device for supply to a remote device, such as a computer or display or printer, directly or via a network. The output data may simply alert the operator to the possibility of an out-of-range contact angle and/or potential collision but more usefully may show the position of the stylus at each measurement point, either as a static image or as an animation, with any out-of-range contact angles and/or potential collision points highlighted, for example shown in a different colour such as red.

If the output data shows any out-of-range contact angles and/or potential collision points, the operator can then select a different traverse angle β and re-run the simulation. If a traverse angle cannot be found that does not result in the simulation indicating an out-of-range contact angle and/or a potential collision, the operator may select a different stylus, for example a stylus with a different shank angle θ and re-run the simulation.

FIG. 12a shows a flow chart illustrating further processes that may be carried out for assisting an operator in correctly setting up the metrological instrument, if the processes shown in FIG. 12 identify an out-of-range contact angle and/or a potential collision.

Thus if the processes shown in FIG. 12 identify an out-of-range contact angle and/or a potential collision, the simulated traverse angle θ and/or stylus characteristics such as the shank angle θ may be adjusted at S110 in FIG. 12a and S101 to S107 of FIG. 12 then repeated at S111. If an out-of-range contact angle and/or a potential collision is detected at S112 then the simulated traverse angle β and/or stylus characteristics such as the shank angle θ may be re-adjusted and S111 to S112 repeated until no out-of-range contact angle and/or a potential collision is detected, at which point adjustments to the traverse angle and/or stylus characteristics may be proposed to the operator by outputting to the resource as discussed above. The process shown in FIG. 12a may try different traverse angles first and only try different stylus characteristics if a traverse angle cannot be found that does not cause an out-of-range contact angle and/or a potential collision, or vice versa. Different stylus characteristics may be selected from stylus characteristics stored in the data store of the metrological apparatus or stylus characteristics for available alternative styli requested from and input by the operator. The stylus characteristic that is adjusted could be the shank angle θ or another characteristic such as the stylus arm or shank length.

FIGS. 13 to 17 show results of simulations (in x, z coordinate space) carried out in accordance with FIG. 12 with FIG. 13 showing the representation of a stylus 11 at various measurement points along a measurement path of a nominal form N with an area of out-of-range contact angles C highlighted (in the actual simulation C is shown in red, the stylus arm in green and the nominal form in blue; it will be appreciated that other colours could be selected). FIG. 14 shows part of FIG. 13 enlarged to illustrate the area of out-of-range contact angles C more clearly whilst FIG. 15 shows an enlargement of one stylus position to show the simulation of the stylus tip 12 and the relative location of the stylus tip centre 12a and the path of the stylus tip centre Nc.

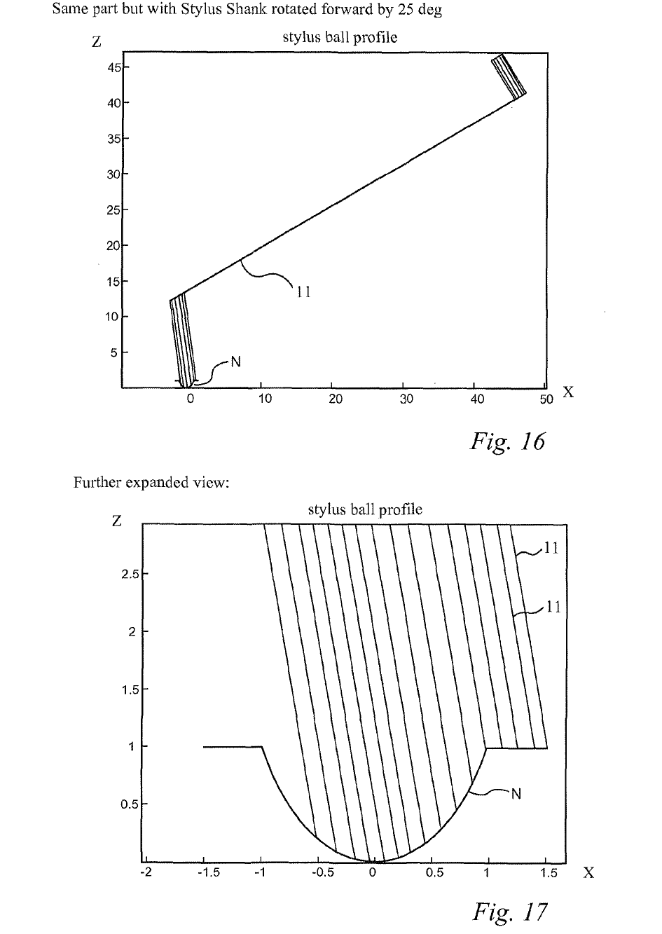

FIGS. 16 and 17 are views similar to FIGS. 13 and 14 to show the effect of changing the shank angle. In this example, the stylus shank has been rotated forwards 25 degrees and the measurement path no longer shows any out-of-range contact angles.

Referring now to FIGS. 1, 2, 5, 6, 7, 8 and 18 to 21, an example metrological apparatus will be described which comprises a metrological instrument and a control apparatus.

FIG. 1 shows a very diagrammatic representation of the metrological instrument 2 of the metrological apparatus 1.

The metrological apparatus 2 has a base 5 that is designed to be supported by a workbench 6. The base 5 carries a column 7 that defines a vertical or z axis reference datum. A column carriage 8 is mounted to the column 7 so as to be movable in the z direction with respect to the column 7. The movement of the column carriage 8 is effected by a motorised drive arrangement (not shown), such as for example a. leadscrew, pulley or other suitable drive arrangement. The base 5 also carries turntable 16 to support a workpiece 14. The turntable 16 has a centring and levelling mechanism (not shown) such as that shown in FIGS. 2 and 3 of GB2,189,604A, the whole contents of which are hereby incorporated by reference.

The column carriage 8 carries a traverse unit 9, which is arranged at an angle β (the transverse angle) to the x-axis (which in the example is represented by the plane of the turntable surface and is generally the horizontal). The transverse unit 9 is movable relative to the column carriage 8 by means of a motorised drive arrangement (not shown) along a straight reference datum (not shown) provided by the traverse unit 9. The direction of this straight reference datum is determined by the orientation of the transverse unit so that the traverse unit 9 is movable in an X direction which extends at the angle β to the x-axis.

The traverse unit 9 carries a measurement probe (or gauge unit) 10 which consists of a pivotally mounted stylus arm (shown very diagrammatically in FIG. 1 in dotted lines within the traverse unit 9) carrying at its free end a stylus arm 11 having a stylus tip 12 which in operation comes into contact with the surface of the workpiece or component under test during a measurement operation so that, as the traverse unit 9 is moved in the measurement direction, the stylus arm 11 pivots to enable the stylus tip 12 to follow surface variations along a measurement path on the surface. Deflection of the stylus arm is detected by a measurement transducer (or displacement provider) 39 shown in dotted lines in FIG. 1. The measurement probe 10 may be mounted to the traverse unit 9 by a y-position adjuster (not shown) so as to be movable in the y-direction with respect to the traverse unit 9. The movement of the measurement probe 10 in the y-direction may be effected by a manual or motorised leadscrew, pulley or other drive arrangement (not shown).

In an example, the traverse unit 9 may be mounted to the column carriage 8 by means of a pivot pin to enable the angle β of the traverse unit 9 with respect to the x-axis to be adjusted. In this particular example, the angle β of the traverse unit 9 is manually adjustable and the traverse unit 9 is held in place at the manually adjusted angle by means of an air brake (not visible in the Figure). As another possibility, the adjustment of the angle β may be automated. As another possibility, the angle β may for some applications be fixed.

FIG. 2 shows a block diagram illustrating functional components of the metrological instrument 2 and the control apparatus 3 of the metrological instrument 1.

Referring now to FIG. 2, the control apparatus 3 is generally a personal computer and has a processing unit 13 coupled via a bus 13a to associated data and program instruction/software storage 14 in the form generally of RAM 15, ROM 16, a mass storage device 17 such as a hard disc drive and at least one removable medium drive 18 for receiving a removable medium (RM) 19, such as a CD-ROM, solid state memory card, DVD, or floppy disc. As another possibility, the removable medium drive may itself be removable, for example it may be an external hard disc drive.

The control apparatus is also coupled via the same or a different bus to input/output devices 20 comprising in this example a display 21, a keyboard 22, a pointing device 23 such as a mouse, a printer 24 and, optionally, a communications device 25 such as at least one of a MODEM and a network card for enabling the control apparatus 3 to communicate signals S via a wired or wireless connection with other control apparatus or computers via a network such as the Internet, an intranet, a WAN or a LAN.

The processing unit 13 is programmed by program instructions and data provided by being at least one of: downloaded as a signal S via the communications device 25; pre-stored in any one or more of ROM 16, RAM 15 and mass storage device 17; read from a removable storage medium 19 received by the removable medium drive 18; and input by the user using the keyboard 22.

The metrological instrument 2 has a data acquisition and processing unit (DAPU) 30 that communicates with the processing unit 13 of the control apparatus 3 via an appropriate link, for example a serial link, 30a to enable data regarding a measurement operation to be communicated to the control apparatus 3.

The control components of the metrological apparatus 2 comprise a column drive controller 31 for driving the carriage 8 up and down the column in the z direction, a measurement direction position controller 32 for driving the measurement probe or gauge unit along the reference datum provided by the traverse unit 9 in the measurement direction X at an angle β to the x-axis and an interferometric z displacement provider 35 for providing a measure of the z displacement of the stylus tip 12 as the stylus arm 11 follows the surface being measured during movement of the traverse unit 9 along a measurement path in a direction at an angle β to the x-axis.

If rotation of the turntable is automated, then the metrological apparatus will also comprise a γ (where γ represents the angle of rotation of the turntable 16 about its spindle axis) position controller 38 for controlling rotation of the turntable 16. Similarly, if the attitude of the traverse unit 9 is adjustable and this adjustment is automated, then a β position controller 36 will be provided for changing the attitude β of the traverse unit 9. γ and β position providers 39, 37 (which may for example be shaft encoders, for example optical shaft encoders, or a linear grating type position provider) are provides to supply signals respectively indicating the angles γ and β to the DAPU 30. Generally the interferometric z displacement provider 35 will be provided within the traverse unit 9.

The measurement direction position controller 32 is associated with a position provider 34 that may be, for example, a shaft encoder associated with a motor providing the position controller 32 or may be a linear grating type of transducer. The column drive 31 may also be associated with a column z position provider 33 (shown in phantom lines in FIG. 2), for example a shaft encoder associated with a motor providing the column drive 31, or the column z position may be determined in an open loop manner directly from the column motor drive signal. As show in FIG. 2, the column drive 31 and position controller 32 (and other controllers if present) are coupled to the control apparatus 3 (via a link 13b and appropriate interfaces, not shown) for control by instructions from the control apparatus 3. At least some of these instructions may be supplied by the user.

The measurement probe or gauge unit is in this example the measurement probe used in the instruments supplied by Taylor Hobson as the Form Talysurf PGI series and is described in detail in U.S. Pat. No. 5,517,307 (the whole contents of which are hereby incorporated by reference) to which reference should be made for further information. In particular the measurement probe or gauge unit may be based on Taylor Hobson's Form Talysurf PGI 1240 metrological instrument, described in the brochure produced by Taylor Hobson entitled “Form Talysurf PGI 1240, Aspherics Measurement system”. This Form Talysurf PGI series of metrological instruments is particularly suited to measuring the surface form of surfaces having significant form because, as described in U.S. Pat. No. 5,517,307, the interferometric z displacement provider 35 uses a curved diffraction grating that has a radius of curvature which is coincident with the axis about which the stylus arm pivots to provide more accurate z displacement measurements over a longer range.

The processing unit is programmed by program instructions to enable carrying out of measurements further details of examples of such programming may be found in WO2010/943906, the whole contents of which are hereby incorporated by reference.

The stylus and traverse unit of the metrological apparatus may have the geometry diagrammatically illustrated in FIGS. 5 to 8 in which:

O is the origin, that is the location at which x=0, z=0
Φ_{A} is the nominal base diameter of the workpiece or component whose surface form is to be measured, for example an aspheric lens mould 100 as shown in solid lines in FIG. 5 or an aspheric lens mounted on the attached to a base, the lens being illustrated by the dot-dash line 101 in FIG. 5;
α is the stylus deflection angle between the line passing through the pivot axis A and the centre of the stylus tip 12 and the x axis and represents the degree of deflection of the stylus arm;
G is the gauge reading which is related to the stylus deflection angle α;
β is the angle of the traverse unit to the x axis;
X is the traverse or measurement direction which extends at the angle β to the x axis;
X₁ is the distance the traverse unit has moved in the traverse or measurement direction X from a zero position X₀;
z(x) is the distance in the z direction of a point on the surface being measured from a top surface of the flat part (the body of the mould or the base upon which the aspheric lens is mounted);
Δx is the distance in the x direction of the centre of the stylus tip 12 from x=0 where x=0 corresponds to the turntable spindle axis on which the component to be measured will be centred and aligned, for example as discussed in WO2100/043906, so that a rotational axis of the component (the optical axis in the case of an aspheric lens) is coincident with and aligned to the spindle axis;
ΔZ_{c} or ΔZ_{col} is the distance in the z direction when the stylus tip is at a measurement point on the surface being measured from the corresponding z position at which G=0 (see FIG. 5);
Δz_{flat} is the distance in the z direction from z=0 to the top surface of any flat component part, part 100 in FIG. 5;
L₀ is the length of the stylus arm 11;
A is the location of the pivot axis of the stylus arm;
α₀ is the pivot offset angle which as shown in FIG. 7 is an angle between a line parallel to the x axis passing through the pivot axis A and a line passing through the pivot axis A and the centre of the stylus tip 12 with the stylus arm parallel to the traverse axis and is determined, as illustrated in FIG. 7, by the offset P of the pivot axis A from the stylus arm, the length of the stylus arm L and the length S of the stylus shank 11a from the stylus arm to the centre of the stylus tip 12;
L is the distance between the centre of the stylus tip 12 and the pivot axis A, which distance is determined by the length of the stylus arm L, the pivot offset P and the length S of the stylus shank 11a from the stylus arm to the centre of the stylus tip 12.

FIGS. 7 and 8 in particular show an example of the geometry and dimensions of the stylus. This data is either pre-stored or input by the operator. Where a number of different styli are available, the operator may select the stylus characteristics data from a number of pre-stored sets of stylus characteristics data. As another possibility, the stylus itself may carry the data in a local non-volatile memory or may carry identification data identifying the stylus so that the control apparatus can select the correct set of stylus data from its data store.

In this example, the stylus data includes the length L₀ of the stylus arm 11, the pivot offset angle α₀ which as shown in FIG. 7 is an angle between a line parallel to the x axis passing through the pivot axis A and a line passing through the pivot axis A and the centre of the stylus tip 12 with the stylus arm parallel to the traverse axis and is determined, as illustrated in FIG. 7, by the offset P of the pivot axis A from the stylus arm, the length of the stylus arm L₀ and the length S of the stylus shank 11a from the stylus arm to the centre of the stylus tip 12, and the length S of the stylus shank 11a from the stylus arm to the centre of the stylus tip 12.

The traverse angle β will generally be input by the operator but could be determined by detecting the degree of rotation using an appropriate transducer as discussed above. The measurement step Xᵢ may be pre-defined but could be operator-selectable.

The stylus characteristics data also includes the geometry and dimensions of the stylus tip. In this example, the stylus tip is in the form of a sphere (or part of a sphere) of given radius r.

FIG. 18 shows a functional block diagram of functionality provided by programming of the control apparatus shown in FIG. 2 for enabling account to be taken of characteristics of a stylus tip of a stylus of the metrological instrument.

As shown in FIG. 18, this functionality includes a data receiver 241 (which may be provided by the input/output devices shown in FIG. 2) to receive data and store the data in a data store 240 which may be provided by, for example, any one or more of the RAM 15, ROM16 and/or mass storage 17 shown in FIG. 2. Data stored in the data store 240 includes: stylus tip data and measurement data representing the results of a measurement procedure during which a stylus tip follows surface variations as the stylus traverses a measurement path along a surface of a workpiece where that measurement data may be represented as values of z at measurement points x to give a measurement data set (x, z). The data may also include traverse data including the traverse angle β and the measurement step X, in the traverse direction; a nominal form of the surface of the workpiece to be measured, that is the form that the surface was designed or intended to have, and the height Δz_{flat} which as set out above is the distance in the z direction from z=0 to the top surface of the flat part 100 and stylus characteristics including, for example, the length L of the stylus arm 11, a pivot offset angle α₀, the length S of a stylus shank projecting from the stylus arm 11 and carrying at its free end the stylus tip 12 and the dimensions and geometry of the stylus tip. The data store 241 also provides storage for re-created surface data.

The functionality shown in FIG. 18 includes: a stylus tip centre determiner 242 that determines the coordinates (xₛ, zₛ) of a centre of the stylus tip along a measurement path; a gradient determiner 243 that determines gradient data for the stylus tip centre locus; a surface re-creator 244 that re-creates the surface form of the measured surface using the stylus tip centre locus and gradient data; and a data output provider 245 for outputting the re-created surface form to a resource such as a display, printer, network connection or another computer.

Processes will now to be described with reference to FIG. 19 for enabling account to be taken of characteristics of a stylus tip of a stylus of the metrological instrument. These processes may be carried out using the functionality described with reference to FIG. 19 or any other appropriate functionality.

In order to explain the processes shown in FIG. 19, reference is made to FIGS. 5 to 8 which illustrate aspects of the geometry of the metrological instrument described above.

Referring to FIGS. 5 to 8, the vector from origin O to pivot location A in FIG. 6 is given by:

\vec{A}=(L+X₁)(î cos(αₒ+β)+\hat{k} sin(αₒ+β))+\hat{k}ΔZ_{col} 19)

where î and \hat{k} are the unit vectors in the x and z directions.

(In the example illustrated in FIG. 5 the traverse unit has been driven in the negative X direction from X₀ and so X₁ has a negative value.)

The vector \vec{B} from origin O to the stylus tip centre in FIG. 6 is given by:

\vec{A}−L(\hat{i} cos α+\hat{k} sin α)=\hat{i}Δx+\hat{k}(ΔZ_{flat}+Z(Δx)(≡\hat{i}Δxₛ+\hat{k}zₛ 20)

The gauge reading G and its relationship with the stylus deflection angle α are given by:

G=L(αₒ+β−α) [symbol] α=αₒ+β−(G/L) 21)

Extracting the orthogonal components (x,z) from equations 19 and 20 allows a pair of relationships to be defined that relate the stylus tip centre values (xₛ,zₛ) in terms of the stylus and instrument parameters as follows:

L cos(β+αₒ)+X cos β−L cos α=xₛ

L sin(β+αₒ)+X sin β+ΔZ_{col}−L sin α=zₛ 22)

Given the relationship above between G and α, equation 22 thus relates the measured data (G, X) to the centre of the stylus tip xₛ, zₛ.

As illustrated by FIG. 20, the locus 200 of the path of the centre of the stylus tip is not coincident with the actual surface form 201.

At S201 in FIG. 19, the centre xₛ, zₛ of the stylus tip is determined. A given surface z=z(x) that is traversed by a stylus tip of radius r generates a stylus-tip-centre locus:

zₛ=z+r cos ψ

xₛ=x−r sin ψ 23)

where (x, z) is the point of contact and r is the stylus tip radius, assuming the stylus tip or at least the part that contacts the surface is of spherical form, and where

$$tan Ψ = \frac{d z}{d x} \qquad 24 )$$

At S202 the gradient of the stylus-tip centre locus is determined. Thus, taking differentials

$$\frac{d {z}_{s}}{d x} = \frac{d z}{d x} - r sin Ψ \frac{d Ψ}{d x} \\ \frac{d {x}_{s}}{d x} = 1 - r cos Ψ \frac{d Ψ}{d x} \qquad 25 )$$

From equation 24):

$$\frac{d Ψ}{d x} = {cos}^{2} Ψ \frac{{d}^{2} z}{d {x}^{2}} \qquad 26 )$$

Giving:

$$\frac{d {z}_{s}}{d {x}_{s}} = \frac{tan Ψ - r sin {Ψcos}^{2} Ψ \frac{{d}^{2} z}{d {x}^{2}}}{1 - r cos {Ψcos}^{2} Ψ \frac{{d}^{2} z}{d {x}^{2}}} = \frac{sin Ψ - r sin Ψ {cos}^{3} Ψ \frac{{d}^{2} z}{d {x}^{2}}}{cos Ψ - r cos {Ψcos}^{3} Ψ \frac{{d}^{2} z}{d {x}^{2}}} \\ ⇒ \frac{d {z}_{s}}{d {x}_{s}} = tan Ψ \qquad 27 )$$

At S203 from the knowledge of the stylus-tip-centre locus, (xₛ, zₛ), its derivative may be established and the surface function (that is the surface form that was measured) directly re-created in accordance with:

$$\begin{matrix}z = {z}_{s} - r cos Ψ \\ x = {x}_{s} + r sin Ψ & 28 ) \\ because \frac{d {z}_{s}}{d {x}_{s}} = \frac{d z}{d x} & 29 )\end{matrix}$$

The above described technique may be extended to three-dimensional surfaces, that is surfaces having form in both the x and y directions.

In an embodiment, the form of the surface being measured may be determined using the determined stylus tip locus xₛ yₛ zₛ:

z=zₛ−r cos ψ

x=xₛ+r sin ψ cos θ

y=yₛ+r sin ψ sin θ

where

$$tan θ = \frac{\partial {z}_{s}}{\partial {y}_{s}} / \frac{\partial {z}_{s}}{\partial {x}_{s}}$$

and where

$$tan Ψ = \frac{\partial {z}_{s}}{\partial {x}_{s}} / cos θ$$

Application of these relationships allows the surface form to be re-created from the stylus tip centre locus.

The form of the surface being measured may be determined using the determined stylus tip locus and the gradient of the stylus tip locus.

It will of course be appreciated that where, as an example described above, the stylus is a pivotally mounted stylus, appropriate correction will be made for the fact that the stylus tip follows an arcuate path as it is deflected as it follows surface variations in the surface being measured.

Accordingly, in a surface form measuring instrument, such as the one discussed above, the surface form can be obtained from the stylus-tip centre loci together with a knowledge of the stylus tip radius as exemplified by the data shown in FIGS. 20 and 21 in which FIG. 20 shows a representation of the locus 200 of the path of the centre of the stylus tip and the actual surface form 201 and FIG. 21 shows a representation the surface form 202 derived from the stylus tip locus 200.

### Modifications and Variations

A person skilled in the art will understand that the techniques described that may be applied to any surface form measuring instrument, including roundness measuring instruments. The techniques described may also be applicable to an axially movable as well as a pivotally movable stylus. The person skilled in the art will also understand that the above described techniques may be used for simulating a measurement of a nominal form as well as for determining a measurement of the form of an actual workpiece.

A person skilled in the art will appreciate that a number of different methods of centring and levelling could be employed with the above-described techniques. For example, as one possibility, mechanical centring is used. It may be possible to use software centring and/or levelling, for example as described in U.S. Pat. No. 5,926,781, the whole contents of which are hereby incorporated by reference, which may enable omission of at least some of the centring and levelling mechanisms discussed herein.

Other forms of centring and levelling mechanism may be used. For example, it may be possible to use wedge assemblies of the type described in the Applicant's International Application Publication No. WO2007/091087, the whole contents of which are hereby incorporated by reference. Other levelling mechanism that do not use wedge assemblies may be used, for example, as discussed in U.S. Pat. No. 4,731,934, the whole contents of which are hereby incorporated by reference.

It will be appreciated that the traverse angle θ could be zero. Also, the stylus need not necessarily be a contact stylus but could be any form of stylus that follows the frame of a surface, although this may require modification of the definition of the stylus tip centre.

In the above example, the stylus tip is in the form of a sphere of given radius r but it could have another form, for example a frusto-conical form with a part-spherical contact surface.

Also, other gauge transducers units than the ones described above may be used, for example it may be possible to use an LVDT gauge or a different form of optical interferometric gauge.

A person skilled in the art will appreciate that the methods and apparatus described herein need not be limited in their application to instruments for the measurement of aspheric, concave or convex surfaces, and may equally be applied to instruments for the measurement of other surfaces.

As one possibility, there is provided a computer program, computer program product, or computer readable medium, comprising computer program instructions to cause a programmable computer to carry out any one or more of the methods described herein.

Various features described above may have advantages with or without other features described above.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A metrological apparatus for measuring a surface characteristic of a workpiece, the apparatus comprising:
a mover to carry out a measurement procedure by effecting relative movement in a measurement direction between a workpiece and a stylus such that the stylus is deflected as a stylus tip of the stylus follows surface variations along a measurement path on a surface of the workpiece;
a transducer to provide a measurement data set in a measurement coordinate system representing the deflection of the stylus at measurement points along the measurement path, the transducer having a measurement range; and
a data processor configured to:
receive nominal surface data representing the expected surface characteristic of the workpiece in a workpiece coordinate system;
determine a relationship between the measurement data in the measurement coordinate system and the nominal surface data in the workpiece coordinate system;
simulate a measurement data set for the nominal surface using the nominal surface data and the determined relationship, the simulation providing a simulated measurement data set having a simulated range of simulated measurement values;
determine whether the simulated range meets a given criterion;
if the simulated range does not meet the given criterion, adjust a selected measurement data value for a selected measurement point and repeat the simulation to determine an adjusted measurement data value for which the simulated range meets the given criterion; and
determine measurement start conditions required for a measurement procedure to provide the adjusted measurement data value for the selected measurement point.

2. A metrological apparatus according to claim 1, wherein the data processor is configured to use as the selected measurement point a first measurement point of a measurement procedure and to use as the given criterion the point at which a difference between a maximum and minimum simulated measurement value is less than a threshold value.

3. (canceled)

4. (canceled)

5. A metrological apparatus according to claim 1, wherein the data processor is configured to use as the adjusted measurement data value a measurement data value based on the selected measurement data value and a difference between maximum and minimum simulated measurement values.

6-11. (canceled)

12. A metrological apparatus according to claim 1, wherein a pivotal mounting is provided for the stylus such that an arm of the stylus pivots about a pivot axis through an angle α as the stylus tip follows surface variations, the measurement coordinate system is given by G, X, where G is related to the angle α and X is the measurement direction, and wherein the workpiece coordinate system is x, z, where x is a direction along a workpiece support surface of the apparatus, z is a normal to the workpiece and X is at an angle β to x.

13-16. (canceled)

17. A metrological apparatus according to claim 12, wherein the data processor is configured to determine the relationship between the measurement data in the measurement coordinate system and the nominal surface data in the workpiece coordinate system and to simulate the measurement data set by simulating the nominal surface form and rotating the simulated nominal surface form to the measurement direction.

18-34. (canceled)

35. A method for facilitating measurement of a surface characteristic of a workpiece using an apparatus comprising:
a mover to carry out a measurement procedure by effecting relative movement in a measurement direction between a workpiece and a stylus such that the stylus is deflected as a stylus tip of the stylus follows surface variations along a measurement path on a surface of the workpiece; and
a transducer to provide a measurement data set in a measurement coordinate system representing the deflection of the stylus at measurement points along the measurement path, the transducer having a measurement range,
the method comprising:
determining a relationship between the measurement data in the measurement coordinate system and nominal surface data representing the expected surface characteristic of the workpiece in a workpiece coordinate system;
simulating a measurement data set for the nominal surface using the nominal surface data and the determined relationship, the simulation providing a simulated measurement data set having a simulated range of simulated measurement values;
determining whether the simulated range meets a given criterion;
if the simulated range does not meet the given criterion, adjusting a selected measurement data value for a selected measurement point and repeating the simulation to determine an adjusted measurement data value for which the simulated range meets the given criterion; and
determining measurement start conditions required for a measurement procedure to provide the adjusted measurement data value for the selected measurement point.

36-57. (canceled)

58. A metrological apparatus for measuring a surface characteristic of a workpiece, the apparatus comprising:
a mover to carry out a measurement by effecting relative movement in a measurement direction between a workpiece support surface and a stylus such that the stylus is deflected as a stylus tip of the stylus follows surface variations along a measurement path on a surface of a workpiece supported on the workpiece support surface;
a transducer to provide measurement data representing the deflection of the stylus at measurement points along the measurement path; and
a data processor configured to:
to receive stylus characteristics data;
to define a representation of the stylus using the stylus characteristics data;
to receive nominal form data representing the expected form of a surface of the workpiece;
to simulate relative movement of the stylus representation and the nominal form along a measurement path to simulate a measurement;
to identify any measurement points along the measurement path for which the relative locations of the stylus representation and the nominal form are undesirable;
to output to a resource data alerting an operator in the event of determination of a measurement point for which the relative locations of the stylus representation and the nominal form are undesirable.

59. A metrological apparatus according to claim 58, wherein the data processor is configured to determine that the relative locations of the stylus representation and the nominal form are undesirable in the event that a contact angle between the stylus tip of the stylus representation and the nominal form is outside a desired contact angle range and the representation of the stylus arm intersects or contacts the nominal form indicating a potential collision point.

60-63. (canceled)

64. A metrological apparatus according to claim 58, wherein the data processor is configured to output data representing the position of the stylus representation relative to the nominal form at different measurement points.

65. (canceled)

66. (canceled)

67. A metrological apparatus according to claim 58, wherein a pivotal support is provided for the stylus so that the stylus pivots about a pivot axis as the stylus tip follows surface variations.

68. A metrological apparatus according to claim 67, wherein the workpiece support surface defines a workpiece coordinate system having an axis x parallel to the workpiece support surface and an axis z normal to the workpiece support surface whilst the measurement direction and the stylus define a measurement coordinate system having a measurement direction X and a measurement value G related to a stylus deflection angle α.

69-75. (canceled)

76. A method of facilitating measurement of a surface characteristic of a workpiece using an apparatus comprising:
a mover to carry out a measurement by effecting relative movement in a measurement direction between a workpiece support surface and a stylus such that the stylus is deflected as a stylus tip of the stylus follows surface variations along a measurement path on a surface of a workpiece supported on the workpiece support surface; and
a transducer to provide measurement data representing the deflection of the stylus at measurement points along the measurement path, the method comprising:
receiving stylus characteristics data;
defining a representation of the stylus using the stylus characteristics data;
receiving nominal form data representing the expected form of a surface of the workpiece;
simulating relative movement of the stylus representation and the nominal form along a measurement path to simulate a measurement;
identifying any measurement points along the measurement path for which the relative locations of the stylus representation and the nominal form are undesirable;
outputting to a resource data alerting an operator in the event of determination of a measurement point for which the relative locations of the stylus representation and the nominal form are undesirable.

77-115. (canceled)

116. A metrological apparatus for measuring a surface characteristic of a workpiece, the apparatus comprising:
a mover to carry out a measurement by effecting relative movement in a measurement direction between a workpiece support surface and a stylus such that the stylus is deflected as a stylus tip of the stylus follows surface variations along a measurement path on a surface of a workpiece supported on the workpiece support surface;
a transducer to provide measurement data representing the deflection of the stylus at measurement points along the measurement path on the surface being measured; and
a data processor configured to:
to determine a location of a centre of the stylus tip at measurement points along a measurement path on a surface of a workpiece, the stylus tip locations defining a stylus tip locus; and
to determine a surface form of the surface being measured using the determined stylus tip locus.

117. A metrological apparatus according to claim 116, wherein the data processor is configured to determine the form of the surface being measured using the determined stylus tip locus and the gradient of the stylus tip locus.

118. A metrological apparatus according to claim 116, wherein the data processor is configured to determine the stylus tip locus in accordance with:
zₛ=z+r cos ψ
xₛ=x−r sin ψ
where (x, z) is the point of contact and r is a radius of the stylus tip or at least the part of the stylus tip that contacts the surface and where
$$tan Ψ = \frac{d z}{d x}$$

119. (canceled)

120. (canceled)

121. A metrological apparatus according to claim 116, wherein a pivotal support is provided for the stylus so that the stylus pivots about a pivot axis as the stylus tip follows surface variations.

122-128. (canceled)

129. A method of measuring a surface characteristic of a workpiece using an apparatus comprising: a mover to carry out a measurement by effecting relative movement in a measurement direction between a workpiece support surface and a stylus such that the stylus is deflected as a stylus tip of the stylus follows surface variations along a measurement path on a surface of a workpiece supported on the workpiece support surface; and a transducer to provide measurement data representing the deflection of the stylus at measurement points along the measurement path on the surface being measured, the method comprising:
determining a location of a centre of the stylus tip at measurement points along a measurement path on a surface of a workpiece, the stylus tip locations defining a stylus tip locus; and
determining a surface form of the surface being measured using the determined stylus tip locus.

130-146. (canceled)

147. A non-transitory computer readable storage medium storing program instructions configured to program a data processor to perform the method claim 35.

148. A non-transitory computer readable storage medium storing program instructions configured to program a data processor to perform the method claim 76.

149. A non-transitory computer readable storage medium storing program instructions configured to program a data processor to perform the method claim 129.
